(19) United States
(12) Patent Application Publication
(10) Pub. No.: US 2006/0147719 A1
(43) Pub. Date: Jul. 6, 2006

(54) Curable composition, underfill, and method

(76) Inventors: Slawomir Rubinsztajn, Ballston Spa, NY (US); John Robert Campbell, Putnam Station, NY (US); Ryan Christopher Mills, Rexford, NY (US); Ananth Prabhakumar, Chandler, AZ (US); Sandeep Shrikant Tanopi, Niskayuna, NJ (US); David Alexander Gibson III, Scotia, NY (US); Florian Johannes Schattenmann, Ballston Lake, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/368,146

(22) Filed: Mar. 3, 2006

Related U.S. Application Data
(63) Continuation-in-part of application No. 11/155,990, filed on Jun. 17, 2005.
Application No. 11/155,990 is a continuation-in-part of application No. 11/006,265, filed on Dec. 7, 2004.
Application No. 11/155,990 is a continuation-in-part of application No. 11/096,160, filed on Apr. 1, 2005.
Application No. 11/096,160 is a continuation-in-part of application No. 10/737,943, filed on Dec. 16, 2003.
Application No. 10/737,943 is a continuation-in-part of application No. 10/654,378, filed on Sep. 3, 2003.
Application No. 11/096,160 is a continuation-in-part of application No. 11/006,265, filed on Dec. 7, 2004.
Application No. 11/006,265 is a continuation-in-part of application No. 10/301,903, filed on Nov. 22, 2002, now abandoned.
Application No. 11/006,265 is a continuation-in-part of application No. 10/301,904, filed on Nov. 22, 2002, now abandoned.
Application No. 11/006,265 is a continuation-in-part of application No. 10/653,371, filed on Sep. 2, 2003.
Application No. 11/006,265 is a continuation-in-part of application No. 10/641,425, filed on Aug. 14, 2003, now abandoned.
Application No. 11/006,265 is a continuation-in-part of application No. 10/736,946, filed on Dec. 16, 2003, now Pat. No. 7,022,410.

(51) Int. Cl. B32B 27/38; B32B 15/02; C08K 3/22

(52) U.S. Cl. 428/413; 523/400; 428/405; 524/430

(57) ABSTRACT

A curable composition is provided, and a method associated therewith. The curable composition may include a curable resin and a finely divided refractory solid. The solid may have a surface area that is greater than about 5 square meters per gram, and a determined density of active surface termination sites per square nanometer of surface area.

### CROSS REFERENCE TO RELATED APPLICATIONS

The patent application is a continuation-in-part patent application of U.S. patent application Ser. No. 11/155,990 filed Jun. 17, 2005 which is a continuation-in-part patent application of U.S. patent application Ser. No. 11/096,160 filed Apr. 1, 2005, which is a continuation-in-part patent application of U.S. patent application Ser. No. 10/737,943 filed Dec. 16, 2003, which is a continuation-in-part patent application of U.S. patent application Ser. No. 10/654,378 filed Sep. 3, 2003; and, of U.S. patent application Ser. No. 11/006,265 filed Dec. 7, 2004, which is a continuation-in-part patent application of U.S. patent application Ser. No. 10/301,903 filed on Nov. 22, 2002, U.S. patent application Ser. No. 10/301,904 filed on Nov. 22, 2002, U.S. patent application Ser. No. 10/653,371 filed on Sep. 2, 2003, and U.S. patent application Ser. No. 10/641,425 filed on Aug. 14, 2003; and, of U.S. Patent application Ser. No. 10/736,946 filed Dec. 16, 2003. The benefit and priority of these patent applications are hereby claimed. The entire contents of each of these patent applications are hereby incorporated by reference in their entirety.

### BACKGROUND

1. Technical Field

The invention may include embodiments that relate to curable composition. The invention may include embodiments that relate to a cured layer formed from the curable composition, and to a device using the cured layer. The invention may include embodiments that relate to a method of making and/or using the curable composition.

2. Discussion of Related Art

Demand for smaller and more sophisticated electronic devices continues to drive the electronic industry towards integrated circuit packages capable of supporting higher input/output (“I/O”) density, and having enhanced performance at smaller die areas. Flip chip technology has been developed to respond to industry demand. But, a flip chip construct may experience undesirable mechanical stress at solder bumps during thermal cycling. The mechanical stress may be due to coefficient of thermal expansion (“CTE”) mismatch between a silicon die and a substrate. The mismatch may result in mechanical and electrical failures of the electronic device. Currently, an underfill resin may be used to fill gaps between silicon chip and substrate to reduce the mechanical stress. Further, the underfill resin may include a silicon filler to reduce CTE mismatch.

The use of silicon filler may be problematic in that the filled underfill resin may obscure guide marks used for wafer dicing, may interfere with the formation of electrical connections during solder reflow operations, and may be difficult to process. It may be desirable to have on or more of a curable composition, a filled resin system, or an electronic device with different properties than those currently available.

### BRIEF DESCRIPTION

In one embodiment, the invention may provide a curable composition. The curable composition may include a curable resin and a finely divided refractory solid. The solid may have a surface area that is greater than about 5 square meters per gram, and a determined density of active surface termination sites per square nanometer of surface area.

In one embodiment, the invention may provide a method of producing a filled curable composition. The method may include reacting a first portion of active termination sites of a plurality of particles with a compatiblizing composition to form compatibilized particles. A second portion of active termination sites of the plurality of particles may be reacted with a passivating composition to form compatibilized and passivated particles. The plurality of compatiblized and passivated particles may be mixed with a curable resin to form the filled curable composition.

### BRIEF DESCRIPTION OF THE DRAWINGS

FIG. 1 is a graph that illustrates a relationship between active termination site density and viscosity; and

FIG. 2 is a graph that illustrates active termination site density versus stability.

### DETAILED DESCRIPTION

The invention may include embodiments that relate to curable composition. The invention may include embodiments that relate to a cured layer formed from the curable composition, and to a device using the cured layer. The invention may include embodiments that relate to a method of making and/or using the curable composition.

Approximating language, as used herein throughout the specification and claims, may be applied to modify any quantitative representation that could permissibly vary without resulting in a change in the basic function to which it is related. Accordingly, a value modified by a term such as “about” may not be limited to the precise value specified. The term “free” may be used in combination with a term, and may include an insubstantial number, or trace amounts, while still being considered free of the modified term. B-stage is a subsequent cure stage of a thermosetting resin in which a partially cured, and/or solvent free, resin may be rubbery, solid, or tack free and may have partially solubility in solvent. Tack free may refer to a surface that does not possess pressure sensitive adhesive properties at about room temperature. By one measure, a tack free surface will not adhere or stick to a finger placed lightly in contact therewith at about 25 degrees Celsius.

Cured refers to a total formulation with reactive groups wherein more than about 50 percent of the reactive groups have reacted. Glass transition temperature may be the temperature as which an amorphous material changes from a hard or brittle state to a soft or plastic state. Transparent refers to a maximum haze percentage of 15 and/or the inability to block electromagnetic radiation of a determined frequency. In certain embodiments, transparent may refer to a maximum haze percentage of less than about 5. A low boiling point component may be a component of a mixture or solution that has a boiling point of less than or equal to about 200 degrees Celsius at about 1 atmosphere.

The term resin may be disclosed throughout the specification and claims, and may refer both to the specifically-named resin and to molecules having a moiety of the named resin. Further, resin may include monomeric units of the resin, oligomers and partially cured molecules of the resin, and fully cured resin materials formed from the monomeric units.

The term polymer may include a reaction product of polymerization; the polymerization product may include all chemical reaction products comprising one or more repeated units derived from a reactive substrate that is lower in molecular weight than the reaction product. Examples of polymerization products may include one or more of homopolymers, heteropolymers, random copolymers, interpolymers, terpolymers, block copolymers, graft copolymers, alternating copolymers, addition polymers, and the like. Alkyl may include one or more of alkyl, branched alkyl, aralkyl, and cycloalkyl radicals. Straight-chain and branched alkyl radicals may be those containing from about 2 to about 20 carbon atoms, inclusive, and include as illustrative non-limiting examples ethyl, propyl, isopropyl, butyl, tertiary-butyl, pentyl, neopentyl, hexyl, octyl, decyl, and dodecyl. Aryl radicals include phenyl and tolyl. Cyclo- or bicycloalkyl radicals represented may be those containing from about 3 to about 12 ring carbon atoms with a total number of carbon atoms less than or equal to about 50. Some illustrative non-limiting examples of cycloalkyl radicals include cyclobutyl, cyclopentyl, cyclohexyl, methylcyclohexyl, and cycloheptyl. Suitable aralkyl radicals may be those containing from about 7 to about 14 carbon atoms; these include, but may be not limited to, benzyl, phenylbutyl, phenylpropyl, and phenylethyl.

Aliphatic radical may be an organic radical having at least one carbon atom, a valence of at least one and may be a linear array of atoms. Aliphatic radicals may include heteroatoms such as nitrogen, sulfur, silicon, selenium and oxygen or may be composed exclusively of carbon and hydrogen. Aliphatic radical may include a wide range of functional groups such as alkyl groups, alkenyl groups, alkynyl groups, halo alkyl groups, conjugated dienyl groups, alcohol groups, ether groups, aldehyde groups, ketone groups, carboxylic acid groups, acyl groups (for example, carboxylic acid derivatives such as esters and amides), amine groups, nitro groups and the like. For example, the 4-methylpent-1-yl radical may be a C₆ aliphatic radical comprising a methyl group, the methyl group being a functional group. Similarly, the 4-nitrobut-1-yl group may be a C₄ aliphatic radical comprising a nitro group, the nitro group being a functional group. An aliphatic radical may be a haloalkyl group that may include one or more halogen atoms, which may be the same or different from each other. Suitable halogen atoms may include fluorine, chlorine, bromine, or iodine. Aliphatic radicals having one or more halogen atoms may include the alkyl halides: trifluoromethyl, bromodifluoromethyl, chlorodifluoromethyl, hexafluoroisopropylidene, chloromethyl, difluorovinylidene, trichloromethyl, bromodichloromethyl, bromoethyl, 2-bromotrimethylene (e.g., —CH₂CHBrCH₂—), and the like. Further examples of aliphatic radicals may include allyl, aminocarbonyl (—CONH₂), carbonyl, dicyanoisopropylidene —CH₂C(CN)₂CH₂—), methyl (—CH₃), methylene (—CH₂—), ethyl, ethylene, formyl (—CHO), hexyl, hexamethylene, hydroxymethyl (—CH₂OH), mercaptomethyl (—CH₂SH), methylthio (—SCH₃), methylthiomethyl (—CH₂SCH₃), methoxy, methoxycarbonyl (CH₃OCO—), nitromethyl (—CH₂NO₂), thiocarbonyl, trimethylsilyl ((CH₃)₃Si—), t-butyldimethylsilyl, trimethoxysilylpropyl ((CH₃O)₃SiCH₂CH₂CH₂—), vinyl, vinylidene, and the like. By way of further example, a “C₁-C₃₀ aliphatic radical” contains at least one and up to about 30 carbon atoms. A methyl group (CH₃—) may be an example of a C₁ aliphatic radical. A decyl group (CH₃(CH₂)₉—) may be an example of a C₁₀ aliphatic radical.

A cycloaliphatic radical may be a radical having a valence of at least one, and may be an array of atoms; the radical further may be cyclic but not aromatic. A cycloaliphatic radical may include one or more non-cyclic components. For example, a cyclohexylmethyl group (C₆H₁₁CH₂—) may be a cycloaliphatic radical, which may include a cyclohexyl ring (the array of atoms, which may be cyclic but which may not be aromatic) and a methylene group (the noncyclic component). The cycloaliphatic radical may include heteroatoms such as nitrogen, sulfur, selenium, silicon and oxygen, or may be composed exclusively of carbon and hydrogen. A cycloaliphatic radical may include one or more functional groups, such as alkyl groups, alkenyl groups, alkynyl groups, halo alkyl groups, conjugated dienyl groups, alcohol groups, ether groups, aldehyde groups, ketone groups, carboxylic acid groups, acyl groups (for example carboxylic acid derivatives such as esters and armides), amine groups, nitro groups and the like. For example, the 4-methylcyclopent-1-yl radical may be a C₆ cycloaliphatic radical comprising a methyl group, the methyl group being a functional group, which may be an alkyl group. Similarly, the 2-nitrocyclobut-1-yl radical may be a C₄ cycloaliphatic radical comprising a nitro group, the nitro group being a functional group. A cycloaliphatic radical may include one or more halogen atoms, which may be the same or different. Halogen atoms include, for example, fluorine, chlorine, bromine, and iodine. Cycloaliphatic radicals having one or more halogen atoms may include 2-trifluoromethylcyclohex-1-yl, 4-bromo difluoromethyl cyclooct-1-yl, 2-chloro difluoro methyl cyclohex-1-yl, hexafluoro isopropylidene 2,2-bis (cyclohex-4-yl) (—C₆H₁₀C(CF₃)₂C₆H₁₀—), 2-chloromethyl cyclohex-1-yl; difluoro methylene cyclohex-1-yl; 4-trichloro methylcyclo hex-1-yloxy, 4-bromo dichloro methyl cyclohex-1-ylthio 2-bromo ethyl cyclo pent-1-yl, 2-bromo propyl cyclohex-1-yloxy (e.g., CH₃CHBrCH₂C₆H₁₀—), and the like. Further examples of cycloaliphatic radicals may include 4-allyloxycyclohex-1-yl, 4-aminocyclohex-1-yl (H₂NC₆H₁₀—), 4-aminocarbonylcyclopent-1-yl (NH₂COC₅H₈—), 4-acetyloxycyclohex-1-yl, 2,2-dicyano isopropylidene bis (cyclohex-4-yloxy) (—OC₆H₁₀C(CN)₂C₆H₁₀O—), 3-methylcyclohex-1-yl, methylenebis (cyclohex-4-yloxy) (—OC₆H₁₀CH₂C₆H₁₀O—), 1-ethylcyclobut -1-yl, cyclopropylethenyl, 3-formyl -2-terahydrofuranyl, 2-hexyl-5-tetrahydrofuranyl; hexamethylene -1,6-bis(cyclohex-4-yloxy) (—OC₆H₁₀(CH₂)₆C₆H₁₀O—); 4-hydroxymethyl cyclohex-1-yl (4-HOCH₂C₆H₁₀—), 4-mercaptomethylcyclohex-1-yl(4-HSCH₂C₆H₁₀—), 4-methylthiocyclohex-1-yl (4-CH₃SC₆H₁₀—), 4-methoxycyclohex-1-yl, 2-methoxycarbonylcyclohex-1-yloxy (2-CH₃OCOC₆H₁₀O—), 4-nitromethylcyclohex-1-yl (NO₂CH₂C₆H₁₀—), 3-trimethyl sily cyclohex-1-yl, 2-t-butyl dimethyl silyl cyclopent-1-yl, 4-trimethoxy silyl ethyl cyclohex-1-yl (e.g. (CH₃O)₃SiCH₂CH₂C₆H₁₀—), 4-vinylcyclo hexen-1-yl, vinylidene bis(cyclohexyl), and the like.

The term “a C₃-C₃₀ cycloaliphatic radical” may include cycloaliphatic radicals containing at least three but no more than 10 carbon atoms. The cycloaliphatic radical 2-tetrahydrofuranyl (C₄H₇O—) represents a C₄ cycloaliphatic radical. The cyclohexylmethyl radical (C₆H₁₁CH₂—) represents a C₇ cycloaliphatic radical.

An aromatic radical may be an array of atoms having a valence of at least one and having at least one aromatic group. The may include heteroatoms such as nitrogen, sulfur, selenium, silicon and oxygen, or may be composed exclusively of carbon and hydrogen. Suitable aromatic radicals may include phenyl, pyridyl, furanyl, thienyl, naphthyl, phenylene, and biphenyl radicals. The aromatic group may be a cyclic structure having 4n+2 “delocalized” electrons where “n” may be an integer equal to 1 or greater, as illustrated by phenyl groups (n=1), thienyl groups (n=1), furanyl groups (n=1), naphthyl groups (n=2), azulenyl groups (n=2), anthracenyl groups (n=3) and the like. The aromatic radical also may include non-aromatic components. For example, a benzyl group may be an aromatic radical, which may include a phenyl ring (the aromatic group) and a methylene group (the non-aromatic component). Similarly a tetrahydronaphthyl radical may be an aromatic radical comprising an aromatic group (C₆H₃) fused to a non-aromatic component —(CH₂)₄—. An aromatic radical may include one or more functional groups, such as alkyl groups, alkenyl groups, alkynyl groups, haloalkyl groups, haloaromatic groups, conjugated dienyl groups, alcohol groups, ether groups, aldehyde groups, ketone groups, carboxylic acid groups, acyl groups (for example carboxylic acid derivatives such as esters and amides), amine groups, nitro groups, and the like. For example, the 4-methylphenyl radical may be a C₇ aromatic radical comprising a methyl group, the methyl group being a functional group, which may be an alkyl group. Similarly, the 2-nitrophenyl group may be a C₆ aromatic radical comprising a nitro group, the nitro group being a functional group. Aromatic radicals include halogenated aromatic radicals such as trifluoromethylphenyl, hexafluoroisopropylidenebis (4-phen-1-yloxy) (—OPhC(CF₃)₂PhO—), chloromethylphenyl, 3-trifluorovinyl-2-thienyl, 3-trichloromethylphen-1-yl (3-CCl₃Ph-), 4-(3-bromoprop-1-yl)phen-1-yl (BrCH₂CH₂CH₂Ph-), and the like. Further examples of aromatic radicals may include 4-allyloxyphen-1-oxy, 4-aminophen-1-yl (H₂NPh-), 3-aminocarbonylphen-1-yl (NH₂COPh-), 4-benzoylphen-1-yl, dicyanoisopropylidenebis(4-phen-1-yloxy) (—OPhC(CN)₂PhO—), 3-methylphen-1-yl, methylenebis(phen-4-yloxy) (—OPhCH₂PhO—), 2-ethylphen-1-yl, phenylethenyl, 3-formyl-2-thienyl, 2-hexyl-5-furanyl; hexamethylene-1,6-bis(phen-4-yloxy) (—OPh(CH₂)₆PhO—), 4-hydroxymethylphen-1-yl (4-HOCH₂Ph-), 4-mercaptomethylphen-1-yl (4-HSCH₂Ph-), 4-methylthiophen-1-yl (4-CH₃SPh-), 3-methoxyphen-1-yl, 2-methoxycarbonylphen-1-yloxy (e.g., methyl salicyl), 2-nitromethylphen-1-yl (—PhCH₂NO₂), 3-trimethylsilylphen-1-yl, 4-t-butyldimethylsilylphenl-1-yl, 4-vinylphen-1-yl, vinylidenebis (phenyl), and the like. The term “a C₃-C₃₀ aromatic radical” may include aromatic radicals containing at least three but no more than 30 carbon atoms. A suitable C₃ aromatic radical may include 1-imidazolyl (C₃H₂N₂—). The benzyl radical (C₇H₇—) represents a C₇ aromatic radical.

A suitable curable resin may include a resin as disclosed herein, such as one or more of an acrylic, urethane, isocyanate, cyanate ester, imide, or epoxy resin. The resins may be multi-functional, for example, the epoxy resin may be multi-functional.

Suitable curable resins may include one or more of oxirane resins, polydimethylsiloxane resins, acrylate resins, other organo-compatibilized polysiloxane resins, polyimide resins, fluorocarbon resins, benzocyclobutene resins, fluorinated polyallyl ethers, polyamide resins, polyimidoamide resins, phenol cresol resins aromatic polyester resins, polyphenylene ether (PPE) resins, bismaleimide triazine resins, fluororesins and a polymeric system which may undergo curing to a crosslinked thermoset material. In one embodiment, the curable thermoset material may contain one or more epoxy resins, acrylate resins, polydimethyl siloxane resins and other organo-compatibilized polysiloxane resins that may form cross-linking networks via free radical polymerization, atom transfer, radical polymerization, ring-opening polymerization, ring-opening metathesis polymerization, anionic polymerization, or cationic polymerization.

According to one embodiment, a resin blend may include an aromatic epoxy resin and one or more of a cycloaliphatic epoxy monomer, aliphatic epoxy monomer, or hydroxy aromatic compound. Useful epoxy resins may include those that could be produced by reaction of a hydroxyl, carboxyl or amine-containing compound. with epichlorohydrin in the presence of a basic catalyst. Epoxy resins may be produced by reaction of a compound containing at least one and two or more carbon-carbon double bonds with peroxide, such as a peroxyacid. The presence of polyfunctional aromatic resins having a relatively increased functionality may increase cross-link density; which may lead to an increase in glass transition temperature. Suitable aromatic epoxy resins may include one or more cresol-novolac epoxy resins, bisphenol-A epoxy resins, bisphenol-F epoxy resins, phenol novolac epoxy resins, bisphenol epoxy resins, biphenyl epoxy resins, 4,4′-biphenyl epoxy resins, polyfunctional epoxy resins, divinylbenzene dioxide, and 2-glycidylphenylglycidyl ether. Examples of trifunctional aromatic epoxy resins may include triglycidyl isocyanurate epoxy, VG3101L manufactured by Mitsui Chemicals America, Inc. (Purchase, N.Y.), and examples of tetrafunctional aromatic epoxy resins may include by ARALDITE MTO163 manufactured by Ciba Specialty Chemicals (Basel, Switzerland). In one embodiment, epoxy resins for use with the disclosure may include cresol-novolac epoxy resins, and epoxy resins derived from bisphenols.

Difunctional aromatic epoxy resin may be exemplified by difunctional epoxy resins such as bisphenol A epoxies, bisphenol B epoxies, and bisphenol F epoxies. Trifunctional aromatic epoxy resins can be exemplified by triglycidyl isocyanurate epoxy VG3101L, manufactured by Mitsui Chemical, and the like, and tetrafunctional aromatic epoxy resins can be exemplified by ARALDITE MTO163 manufactured by Ciba Geigy.

Multi-functional epoxy monomers may be present in the resin blend in an amount in a range of from about 1 weight percent to about 5 weight percent, from about 5 weight percent to about 35 weight percent, from about 35 weight percent to about 70 weight percent, or greater than about 70 weight percent based on the total composition. In some embodiments, where utilized, aromatic epoxy monomers may included in the resin component of the second fluxing resin composition in amounts in a range of from about 1 weight percent to about 25 weight percent, from about 25 weight percent to about 75 weight percent, or greater than about 75 weight percent of the resin component of the second fluxing composition. An amount of epoxy resin may be adjusted to correspond to molar amount of other reagents such as novolac resin hardeners.

Suitable cycloaliphatic epoxy resins may include one or more of 3-(1,2-epoxy ethyl)-7-oxabicyclo heptane; hexanedioic acid bis (7-oxabicyclo heptylmethyl) ester; 2-(7-oxabicyclohept-3-yl)-spiro(1,3-dioxa-5,3′-(7)-oxabicycloheptane; methyl 3,4-epoxycyclohexane carboxylate, 3-cyclohexenyl methyl-3-cyclohexenyl carboxylate diepoxide, 2-(3,4-epoxy)cyclohexyl-5,5-spiro-(3,4-epoxy)cyclohexane-m-dioxane, 3,4-epoxy cyclohexylalkyl-3,4-epoxycyclohexanecarboxylate, 3,4-epoxy-6-methyl cyclohexylmethyl-3,4-epoxy-6-methyl cyclohexane carboxylate, vinyl cyclohexanedioxide, bis(3,4-epoxy cyclohexylmethyl) adipate, bis(3,4-epoxy-6-methylcyclohexylmethyl)adipate, exo-exo bis(2,3-epoxy cyclopentyl) ether, endo-exo bis(2,3-epoxy cyclopentyl)ether, 2,2-bis(4-(2,3-epoxy propoxy)cyclohexyl)propane, 2,6-bis(2,3-epoxy propoxy cyclohexyl-p-dioxane), 2,6-bis(2,3-epoxy propoxy)norbornene, diglycidyl ether of linoleic acid dimer, limonene dioxide, 2,2-bis(3,4-epoxy cyclohexyl)propane, dicyclo pentadiene dioxide, 1,2-epoxy-6-(2,3-epoxy propoxy)hexahydro-4,7-methanoindane, p-(2,3-epoxy) cyclopentyl phenyl-2,3-epoxy propylether, 1-(2,3-epoxy propoxy)phenyl-5,6-epoxy hexahydro-4,7-methanoindane, o-(2,3-epoxy)cyclopentyl phenyl-2,3-epoxy propyl ether), 1,2-bis(5-(1,2-epoxy)-4,7-hexahydro methanoindanoxyl) ethane, cyclo pentenyl phenyl glycidyl ether, cyclohexanediol diglycidyl ether, butadiene dioxide, dimethylpentane dioxide, diglycidyl ether, 1,4-butanedioldiglycidyl ether, diethylene glycol diglycidyl ether, and dipentene dioxide, and diglycidyl hexahydrophthalate. A suitable cycloaliphatic epoxy resin may be 3-cyclohexenylmethyl-3-cyclohexenylcarboxylate diepoxide.

Suitable alicyclic epoxy resins can be exemplified by difunctional epoxies such as ARALDITE CY179 (Ciba Specialty Chemicals), UVR6105 (Dow Chemical) and ESPE-3150 (Daicel (U.S.A.), Inc. (Fort Lee, N.J.)), trifunctional epoxies such as EPOLITE GT300 (Daicel), and tetrafunctional epoxies such as EPOLITE GT400 (also from Daicel).

Cycloaliphatic epoxy monomers may be included in a curable resin composition in an amount in a range of from about 0.3 weight percent to about 0.5 weight percent, from about 0.5 weight percent to about 10 weight percent, from about 10 weight percent to about 15 weight percent, or greater than about 15 weight percent of the resin blend.

Suitable aliphatic epoxy resins may include compositions having an aliphatic group, such as C₄-C₂₀ aliphatic resins or polyglycol type resins. The aliphatic epoxy resin may be either monofunctional, i.e. one epoxy group per molecule, or polyfunctional, i.e. two or more epoxy groups per molecule. In one embodiment, the aliphatic epoxy resin may include one or more of butadiene dioxide; dimethylpentane dioxide; diglycidyl ether; 1,4-butanedioldiglycidyl ether; diethylene glycol diglycidyl ether; or dipentene dioxide. Such aliphatic epoxy resins may be available commercially, such as DER 732 and DER 736 from Dow Chemical (Midland, Mich.).

The aliphatic epoxy monomers may be present in an amount in a range of from about 0.3 weight percent to about 0.5 weight percent, from about 0.5 weight percent to about 10 weight percent, from about 10 weight percent to about 15 weight percent, or greater than about 15 weight percent of the resin blend. In some embodiments, where utilized, aliphatic epoxy monomers may be may included in the resin component of the second fluxing resin composition in amounts in a range of from about 1 weight percent to about 50 weight percent of the resin component of the second fluxing composition, or in a range of from about 5 weight percent to about 25 weight percent.

Suitable silicone-epoxy resins may have a formula (I):
MₐM′_{b}D_{c}D′_{d}TₑT′_{f}Q_{g} (I)
where the subscripts a, b, c, d, e, f, and g may be zero or a positive integer, subject to the limitation that the sum of the subscripts b, d and f may be one or greater; where M has the formula: R¹₃SiO_{1/2}; M′ has the formula: (Z)R²₂SiO_{1/2}; D has the formula: R³₂silica_{/2}; D′ has the formula: (Z)R⁴silica_{/2}; T has the formula: R⁵SiO_{3/2}; T′ has the formula: (Z)SiO_{3/2}; and Q has the formula SiO_{4/2}. Each of R¹, R², R³, R⁴, R⁵ may be independently at each occurrence a hydrogen atom, about C1-C22 alkyl, about C1-C22 alkoxy, about C2-C22 alkenyl, about C6-C14 aryl, about C6-C22 alkyl-substituted aryl, or about C6-C22 arylalkyl, and may be halogenated, for example, fluorinated to contain fluorocarbons such as about C1-C22 fluoroalkyl, or may contain amino groups to form aminoalkyls, for example aminopropyl or aminoethylaminopropyl, or may contain polyether units of the formula (CH₂CHR⁶O)ₖ where R⁶ may be methyl or hydrogen and k may be in a range of from about 4 to about 20; and Z, independently at each occurrence, may represent a radical containing an epoxy group. Normal and branched alkyl radicals may contain in a range of from about 1 or about 12 carbon atoms, and may include as illustrative non-limiting examples methyl, ethyl, propyl, isopropyl, butyl, tertiary-butyl, pentyl, neopentyl, and hexyl. Cycloalkyl radicals represented may be those containing in a range of from about 4 to about 12 ring carbon atoms. Some illustrative non-limiting examples of these cycloalkyl radicals may include cyclobutyl, cyclopentyl, cyclohexyl, methylcyclohexyl, and cycloheptyl. Aralkyl radicals may be those containing in a range of from about 7 to about 14 carbon atoms; these may include, but may be not limited to, benzyl, phenylbutyl, phenylpropyl, and phenylethyl. Aryl radicals used in the various embodiments of the disclosure may include those containing in a range of from about 6 to about 14 ring carbon atoms. Some illustrative non-limiting examples of these aryl radicals may include phenyl, biphenyl, and naphthyl. An illustrative non-limiting example of a halogenated moiety suitable may be 3,3,3-trifluoropropyl. Combinations of epoxy monomers and oligomers may be also contemplated for use with the disclosure.

In one embodiment, the composition may include a combination of two or more curable resins, including at least a second resin. The second resin may be capable of fluxing. The resin of the second fluxing composition may be an epoxy resin, and may be combined with an epoxy hardener, and, optionally, one or more of a catalyst, hydroxyl-containing moiety, reactive organic diluent, adhesion promoter, flame retardant, or the like.

Examples of the second fluxing resin may include combinations of 3-cyclohexenylmethyl-3-cyclohexenylcarboxylate diepoxide (commercially available as UVR 6105 from Dow Chemical Co.), bisphenol-F epoxy resin (including RSL-1739 which may be commercially available from Resolution Performance Product), methyl hexahydrophthalic anhydride (“MHHPA”), catalysts including salts of nitrogen-containing compounds such as POLYCAT SA-1 (from Air Products), and organic compounds having a hydroxyl-containing moiety such as 3-ethyl-3-hydroxy methyl oxetane, (commercially available as UVR 6000 from Dow Chemical Co.). In some embodiments, a bisphenol-A epoxy resin (such as RSL-1462 from Resolution Performance Product) may be used in place of the bisphenol-F resin. In other embodiments, an additional difunctional siloxane anhydride epoxy hardener, such as 5,5′-(1,1,3,3,5,5-hexamethyl-1,5-trisiloxanediyl)bis(hexahydro-4,7-methanoisobenzofuran-1,3-dione) (TriSDA) may be may included. Where a bisphenol epoxy resin may be utilized, the bisphenol resin may be present in the epoxy component of the second fluxing resin in an amount in a range of from about 1 weight percent to about 25 weight percent of the resin composition, from about 25 weight percent to about 75 weight percent, or from about 75 weight percent to 100 weight percent.

In some embodiments, where utilized, cycloaliphatic epoxy monomers may be may included in the second fluxing resin composition in amounts in a range of from about 1 weight percent to about 100 weight percent of the resin component of the second fluxing composition, or in a range of from about 25 weight percent to about 75 weight percent. A suitable cycloaliphatic epoxy monomer may include one or both of 3-cyclohexenylmethyl-3-cyclohexenyl carboxylate diepoxide (commercially available as UVR 6105 from Dow Chemical (Midland, Mich.) or bisphenol-F epoxy resin (commercially available as RSL-1739 from Resolution Performance Product). In another embodiment, a suitable mixture may include a combination of 3-cyclohexenylmethyl-3-cyclohexenyl carboxylate diepoxide and bisphenol-A epoxy resin (commercially available as RSL-1462 from Resolution Performance Product).

Examples of organic compounds containing hydroxyl moiety include alkane diols and bisphenols. The alkane diol may be straight chain, branched or cycloaliphatic and may contain from 2 to 12 carbon atoms. Examples of such diols include but may be not limited to ethylene glycol; propylene glycol; i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and combinations of any of the foregoing. Further examples of diols include bisphenols. Suitable bisphenols include those represented by the formula (II):
HO-D-OH (II)
wherein D may be a divalent aromatic radical. At least about 50 percent of the total number of D groups may be aromatic organic radicals and the balance thereof may be aliphatic, alicyclic, or aromatic organic radicals. In one embodiment, D has the structure of the formula (III): 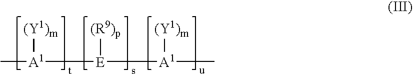
wherein A¹ represents an aromatic group such as phenylene, biphenylene, and naphthylene. E may be an alkylene or alkylidene group such as methylene, ethylene, ethylidene, propylene, propylidene, isopropylidene, butylene, butylidene, isobutylidene, amylene, amylidene, and isoamylidene. When E may be an alkylene or alkylidene group, it also may consist of two or more alkylene or alkylidene groups connected by a moiety different from alkylene or alkylidene, such as an aromatic linkage; a tertiary amino linkage; an ether linkage; a carbonyl linkage; a silicon-containing linkage such as silane or siloxy; or a sulfur-containing linkage such as sulfide, sulfoxide, or sulfone; or a phosphorus-containing linkage such as phosphinyl or phosphonyl. In addition, E may be a cycloaliphatic group, such as cyclopentylidene, cyclohexylidene, 3,3,5-trimethylcyclohexylidene, methylcyclo-hexylidene, 2-{2.2.1}-bicycloheptylidene, neopentylidene, cyclopentadecylidene, cyclododecylidene, and adamantylidene. R⁹ represents hydrogen or a monovalent hydrocarbon group -such as alkyt, aryl, aralkyl, alkaryl, cycloalkyl, or bicycloalkyl.

Y¹ may be a halogen, such as fluorine, bromine, chlorine, and iodine; a tertiary nitrogen group such as dimethylamino; a group such as R⁹ above, or an alkoxy group such as OR wherein R may be an alkyl or aryl group. Y¹ may be inert to and unaffected by the reactants and reaction conditions used to prepare the polyester carbonate. The letter “m” represents any integer from and including zero through the number of positions on A¹ available for substitution; “p” represents an integer from and including zero through the number of positions on E available for substitution; “t” represents an integer equal to at least one; “s” may be either zero or one; and “u” represents any integer including zero.

In the aforementioned bisphenol in which D may be represented above, when more than one Y substituent may be present, they may be the same or different. For example, the Y¹ substituent may be a combination of differing halogens. The R⁹ substituent may be the same or different if more than one R⁹ substituent may be present. Where “s” may be zero and “u” may be not zero, the aromatic rings may be directly joined with no intervening alkylidene or other bridge. The positions of the hydroxyl groups and Y¹ on the aromatic nuclear residues A¹ can be varied in the ortho, meta, or para positions and the groupings can be in vicinal, asymmetrical or symmetrical relationship, where two or more ring carbon atoms of the hydrocarbon residue may be substituted with Y¹ and hydroxyl groups.

Suitable aromatic dihydroxy compounds may include 4,4′-(3,3,5-trimethylcyclohexylidene)-diphenol; 2,2-bis(4-hydroxyphenyl)propane (commonly known as bisphenol A); 2,2-bis(4-hydroxy-3,5-dimethylphenyl)propane; 2,4′-dihydroxydiphenylmethane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl)ethane; 2,2-bis(3-phenyl-4-hydroxyphenyl)propane; bis(4-hydroxyphenyl)cyclohexylmethane; 2,2-bis(4-hydroxyphenyl)-1-phenylpropane; 2,2,2′,2′-tetrahydro-3,3,3′,3′-tetramethyl-1,1′-spirobi(1H-indene)-6,6′-diol (SBI); 2,2-bis(4-hydroxy-3-methylphenyl)propane (DMBPC); resorcinol; and C₁₋₃ alkyl-substituted resorcinols. A 2,2-bis(4-hydroxyphenyl)propane may be used. Combinations of organic compounds containing hydroxyl moiety can also be used.

In one embodiment, a trifunctional epoxy monomer such as triglylcidyl isocyanurate may be added to the composition to provide a multi-functional epoxy resin.

Two or more epoxy resins can be used in combination; e.g., a mixture of an alicyclic epoxy and an aromatic epoxy. In the case, it may be particularly favorable to use an epoxy mixture containing at least one epoxy resin having three or more functionalities, to thereby form an underfill resin having low CTE, good fluxing performance, and a high glass transition temperature. The epoxy resin can include a trifunctional epoxy resin, in addition to at least a difunctional alicyclic epoxy and a difunctional aromatic epoxy.

Suitable oxirane resins may include one or more curable monomers and oligomers of epoxy resins that may be blended with compatibilized and passivated particles. Epoxy resins may be produced by reaction of a hydroxyl, carboxyl or amine containing compound with epichlorohydrin, in the presence of a basic catalyst, such as a metal hydroxide. Also included may be epoxy resins produced by reaction of a compound containing one or more carbon-carbon double bonds with a peroxide.

Suitable epoxy resins for the invention may be cycloaliphatic and aliphatic epoxy resins. Aliphatic epoxy resins include compounds that contain at least one aliphatic group and at least one epoxy group. Examples of aliphatic epoxies include, butadiene dioxide, dimethylpentane dioxide, diglycidyl ether, 1,4-butane-dioldiglycidyl ether, diethylene glycol diglycidyl ether, and dipentene dioxide.

Cycloaliphatic epoxy resins may be well known to the art and, as described herein, may be compounds that contain at least about one cycloaliphatic group and at least one oxirane group. Suitable cycloalipahtic epoxies may include a cycloaliphatic group and at least two oxirane rings per molecule. Specific examples include 3-cyclohexenylmethyl-3-cyclohexenylcarboxylate diepoxide, 2-(3,4-epoxy)cyclohexyl-5,5-spiro-(3,4-epoxy)cyclohexane-m-dioxane, 3,4-epoxycyclo-hexylalkyl-3,4-epoxycyclohexanecarboxylate, 3,4-epoxy-6-methylcyclo hexylmethyl-3,4-epoxy-6-methylcyclohexane carboxylate, vinyl cyclohexane dioxide, bis(3,4-epoxy cyclohexylmethyl)adipate, bis 3,4-epoxy-6-methylcyclohexyl methyl)adipate, exo-exo bis(2,3-epoxy cyclopentyl)ether, endo-exo bis(2,3-epoxy cyclopentyl)ether, 2,2-bis(4-(2,3-epoxy propoxy)cyclohexyl)propane, 2,6-bis 2,3-epoxy propoxy cyclohexyl-p-dioxane), 2,6-bis(2,3-epoxy propoxy) norbomene, the diglycidyl ether of linoleic acid dimer, limonene dioxide, 2,2-bis(3,4-epoxy cyclohexyl)propane, dicyclo pentadiene dioxide, 1,2-epoxy-6-(2,3-epoxy propoxy)hexahydro-4,7-methanoindane, p-(2,3-epoxy)cyclopentyl phenyl-2,3-epoxy propyl ether, 1-(2,3-epoxy propoxy)phenyl-5,6-epoxy hexa-hydro-4,7-methanoindane, o-(2,3-epoxy)cyclopentyl phenyl-2,3-epoxypropyl ether), 1,2-bis(5-(1,2-epoxy)-4,7-hexahydro methanoindanoxyl)ethane, cyclopentenyl phenyl glycidyl ether, cyclohexanediol diglycidyl ether, and diglycidyl hexahydrophthalate. In one embodiment, the cycloaliphatic epoxy resin may be 3-cyclohexenylmethyl-3-cyclohexenylcarboxylate diepoxide.

Suitable aromatic epoxy resins may include bisphenol-A epoxy resins, bisphenol-F epoxy resins, phenol novolac epoxy resins, cresol-novolac epoxy resins, biphenol epoxy resins, biphenyl epoxy resins, 4,4′-biphenyl epoxy resins, polyfunctional epoxy resins, divinylbenzene dioxide, and 2-glycidylphenylglycidyl ether.

A second curable fluxing resin composition may be a liquid having a viscosity in a range of from about 50 centipoise to about 100,000 centipoise, or in a range of from about 1000 centipoise to about 20,000 centipoise at 25 degrees Celsius before the composition may be cured.

In one embodiment, a plurality of particles (i.e., silica filler) may be compatiblized and passivated by treatment with at least one organoalkoxysilane and at least one organosilazane. In a sequential treatment, the organoalkoxysilane may be applied or reacted with at least a portion of active termination sites on the surface of the filler, and the organosilazane may be applied or reacted with at least a portion of the active termination sites that remain after the reaction with the organoalkoxysilane.

After the reaction with the organoalkoxysilane, the otherwise phase incompatible filler may be relative more compatible with an organic phase, such as an organic resin. An increase in the compatibility or dispersability of the filler in a matrix may be referred to herein as “compatibilized”.

Even though phase compatible with the pendant organic groups from the reaction with the organoalkoxysilane, residual active termination sites on the surface of the filler may initiate premature crosslinking of the organic resin. Thus, the phase compatible filler may be passivated by the capping of the active termination sites by the organosilazane. The phase compatible and passivated filler may be mixed with a curable resin to form a curable composition. The curable composition may be a stable filled resin system. The organoalkoxysilane and the organosilazane may be examples of a phase compatiblizer and a passivator, respectively. In one embodiment, a curable composition may include a curable resin a solvent and a dispersion of the compatibilized and passivated filler.

Suitable filler may include a finely divided refractory solid material. In one embodiment, the filler starting material may include a colloidal silica. The silica may be a dispersion of submicron-sized silica (silica) particles in an aqueous or other solvent medium. The dispersion may include a silica content of less than about 10 weight percent, an amount in a range of from about 10 weight percent to about 30 weight percent, from about 30 weight percent to about 60 weight percent, from about 60 weight percent to about 85 weight percent, or greater than about 85 weight percent of silicon dioxide (silica).

The average particle size of the colloidal silica may be in a range of from about 1 nanometer (nm) to about 5 nanometers, from about 5 nanometers to about 50 nanometers, or from about 50 nanometers to about 75 nanometers. The average particle size may be in a range of from about 75 nanometers to about 100 about nanometers, from about 100 nanometers to about 250 nanometers, or greater than about 250 nanometers. In one embodiment, the above disclosed range limitations may refer to a maximum particle size rather than an average particle size.

The colloidal silica may be compatibilized with an organoalkoxysilane to form a compatibilized silica particles that may be compatible or dispersible in an organic or non-polar liquid phase. Organoalkoxysilanes used to compatibilize the colloidal silica may be may included within the formula:
(R⁷)ₐSi(OR⁸)₄₋ₐ
where R⁷ may be independently at each occurrence an about C1-C18 monovalent hydrocarbon radical, optionally further compatibilized with alkyl acrylate, alkyl methacrylate or an epoxide group, or an about C6-C14 aryl or alkyl radical, R⁸ may be at each occurrence independently an about C1-C18 monovalent hydrocarbon radical or a hydrogen radical and “a” may be a whole number equal to 1 to 3 inclusive. The organoalkoxysilanes may include one or more of phenyl trimethoxy silane, 2-(3,4-epoxy cyclohexyl)ethyl trimethoxy silane, 3-glycidoxy propyl trimethoxy silane, and methacryloxy propyl trimethoxy silane, and the like. In one embodiment, phenyl trimethoxysilane may be used to compatibilize the colloidal silica. In one embodiment, phenyl trimethoxysilane may be used to compatibilize the colloidal silica. A combination of functional group types may be suitable.

An organoalkoxysilane may be present in an amount less than about 0.5 weight percent, in a range of from about 0.5 weight percent to about 5 weight percent, or about 5 weight percent to about 60 weight percent based on the weight of silicon dioxide contained in the colloidal silica in the resin blend.

The compatibilization of colloidal silica may be performed by adding the compatibilization agent to an aqueous dispersion of colloidal silica to which an aliphatic alcohol has been added. The resulting composition comprising the compatibilized silica particles and the compatibilization agent in the aliphatic alcohol may be defined herein as a pre-dispersion. The aliphatic alcohol may be selected from isopropanol, t-butanol, 2-butanol, and combinations thereof. The amount of aliphatic alcohol may be in a range of from about 1 fold to about 10 fold by weight of the amount of silicon dioxide present in the aqueous colloidal silica pre-dispersion.

The resulting organo-compatibilized silica particles may be treated with an acid or base to neutralize the pH. An acid or base as well as other catalyst promoting condensation of silanol and alkoxysilane groups may be used to aid the compatibilization process. Such catalysts may include organo-titanate and organo-tin compounds such as tetrabutyl titanate, titanium isopropoxy bis(acetylacetonate), dibutyltin dilaurate, or combinations thereof. In some cases, stabilizers such as 4-hydroxy-2,2,6,6-tetramethylpiperidinyloxy (i.e. 4-hydroxy TEMPO) may be added to the pre-dispersion. The resulting pre-dispersion may be heated in a range of from about 50 degrees Celsius to about 100 degrees Celsius for a period in a range of from about 1 hour to about 12 hours. A curing time range of from about 1 hour to about 5 hours may be adequate.

The cooled transparent pre-dispersion may be further treated with a passivating agent as disclosed herein to form a final dispersion. Optionally, curable monomers or oligomers and aliphatic solvent may be added during this process step. Suitable additional solvent may be selected from isopropanol, 1-methoxy-2-propanol, 1-methoxy-2-propyl acetate, toluene, and combinations of two or more thereof. The final dispersion of the compatibilized and passivated particles may be treated with acid or base or with ion exchange resins to remove acidic or basic impurities.

The final dispersion of compatibilized and passivated particles (having been compatibilized and passivated as disclosed herein) may be hand-mixed, or may be mixed by one or more of dough mixers, chain mixers, or planetary mixers depending on application influenced factors. Such factors may include viscosity, reactivity, particle size, batch size, and process parameters—such as temperature. The blending of the dispersion components may be performed in batch, continuous, or semi-continuous mode.

The final dispersion of the compatibilized and passivated particles may be concentrated under a vacuum in a range of from about 0.5 Torr to about 250 Torr and at a temperature in a range of from about 20 degrees Celsius to about 140 degrees Celsius to remove any low boiling components such as solvent, residual water, and combinations thereof to give a transparent dispersion of compatibilized and passivated silica particles which may optionally contain curable monomer, here referred to as a final concentrated dispersion. Removal of low boiling components may be defined herein as removal of low boiling components to give a concentrated silica dispersion containing from about 15 weight percent to about 80 weight percent silica.

In some instances, the pre-dispersion or the final dispersion of the compatibilized and passivated silica particles may be further reacted with a compatibilization agent and/or a passivating agent. Low boiling components may be at least partially removed. Subsequently, an second capping agent or passivating agent that may react with any remaining or residual hydroxyl functionality (left after the first pass through the compatibilizing and passivating process) of the compatibilized and passivated particles may be added in an amount in a range of from about 0.05 times to about 10 times the amount by weight of silicon dioxide present in the pre-dispersion or final dispersion. Partial removal of low boiling components may remove at least about 10 weight percent of the total amount of low boiling point components, an amount of low boiling point components in a range of from about 10 weight percent to about 50 weight percent, or greater than about 50 weight percent of the total amount of low boiling point components. For at least the second pass through the compatibilizing and passivating process, an effective amount of capping agent may react with surface functional groups of the compatibilized and passivated particles. In one embodiment, the compatibilized and passivated particles may have, after final processing, at least 10 weight percent, at least 20 weight percent, or at least 35 weight percent fewer free hydroxyl groups present compared to a corresponding group of unpassivated particles.

In one embodiment, a finely divided refractory solid may have a surface area that may be greater than about 5 square meters per gram, and a density of active surface termination sites per square nanometer of surface area sufficiently low that a curable resin that contains less than about 99 percent by weight of the solid has a stability ratio of less than about 3 after a period of about two weeks.

Stability, as used herein in the specification and claims, refers to the ratio of viscosity of a mixture of the solid and the curable resin measured initially after mixing, and measured again after a period of time, e.g., one week, two weeks, and the like.

Suitable solids may have a surface area greater than about 20 square meters per gram, greater than about 60 square meters per gram, or greater than about 150 square meters per gram. The solid may include a plurality of nano-particles having an average diameter in a range of from about 1 nanometer to about 100 nanometers. The nano-particles have one or more of a spherical, amorphous or geometric morphology. In one embodiment, the nano-particles may be amorphous. Suitable nano-particles may be porous, non-porous, or a combination thereof. The pores may be uniform or may be randomly shaped and/or sized.

A suitable solid may include one or more metal or metalloid. In one embodiment, the solid may include aluminum, antimony, arsenic, beryllium, boron, carbon, chromium, copper, gallium, gold, germanium, indium, iron, hafnium, magnesium, manganese, molybdenum, phosphorous, silicon, silver, titanium, tungsten, or zirconium, or the like, or an alloy of two or more thereof. In one embodiment, the solid may include one or more of arsenic, aluminum, boron, gallium, germanium, silicon, titanium, or an oxide or nitride thereof, such as alumina, silica, titania, boronitride, and the like.

A suitable solid oxide may include silicon oxide, and the active surface termination site may include a silanol group. Another suitable solid oxide may include aluminum oxide (alumina) and the active surface termination site may include a hydroxyl group. A suitable solid nitride may have the active surface termination site include an amide or an imide.

In one embodiment, the density of active termination sites may be controlled to be about 6 or less, about 5 or less, about 4.75 or less, or in a range of from about 10 to about 1, from about 5 to about 3, or from about 4.5 to about 4.0. A suitable stability ratio, as the ratio of viscosity (two weeks/initial), may be less than about 5, less than about 4, less than about 3 less than about 2, or about 1.

As noted hereinabove, passivating or capping active termination sites may be accomplished by, for example, a sequential treatment. A first portion of active surface termination sites may be reacted with a compatiblizing composition or a. A suitable functionalizing composition may include those disclosed hereinabove, such as an alkoxysilane having an organic moiety that may be one or more of acrylate, alkyl, phenyl, cyclohexyloxy, or glycidyl. Of the remaining active termination sites, a second portion may be reacted with a passivating composition, such as a silazane or other capping agent as disclosed herein.

Colloidal silica may be a dispersion of submicron-sized silica (SiO₂) particles in an aqueous or other solvent medium. The colloidal silica contains up to about 85 weight percent of silicon dioxide (SiO₂), and up to about 80 weight percent of silicon dioxide. The total content of silicon dioxide may be in the range from about 0.001 to about 1 weight percent, from about 1 weight percent to about 10 weight percent, from about 10 weight percent to about 20 weight percent, from about 20 weight percent to about 50 weight percent, from about 50 weight percent to about 90 weight percent of the total curable epoxy formulation weight. The particle size of the colloidal silica may be in a range of from about 1 nanometer (nm) to about 20 nm, from about 20 nm to about 50 nm, from about 50 nm to about 150 nm, from about 150 nm to about 250 nm, from about 250 nm to about 500 nm. A cured epoxy formation comprising particles having a size in the range exhibits an increased T_{g} as compared to cured formulations that do not comprise particle size in the range. In another embodiment, silica particles having two distinct size ranges (a bimodal distribution) may be included in an epoxy formulation of the invention: the first range from about 1 nm to about 250 nm, and the second range from about 0.5 micrometer (or 500 nm) to about 10 micrometers (the silica particles in the second size range may be herein termed “micrometer-sized silica.” A second range may be from about 0.5 micrometer to about 2 micrometers, or from about 2 micrometer to about 5 micrometers. The colloidal silica may be compatibilized with an organoalkoxysilane to form an organo-compatibilized colloidal silica. Furthermore, the micrometer-sized silica may be advantageously compatibilized with an organoalkoxysilane that may be the same or different from the organoalkoxysilane that may be used to compatibilize the colloidal silica particles. When a formulation contains both size ranges of silica particles, the total content of silicon dioxide may be in the range from about 0.001 to about 90 weight percent of the total curable epoxy formulation weight.

The compatibilization of colloidal silica may be performed by adding the organoalkoxysilane compatibilization agent to a commercially available aqueous dispersion of colloidal silica in the weight ratio described above to which an aliphatic alcohol has been added. The resulting composition comprising the compatibilized colloidal silica and the organoalkoxysilane compatibilization agent in the aliphatic alcohol may be defined herein as a pre-dispersion. The aliphatic alcohol may be selected from but not limited to isopropanol, t-butanol, 2-butanol, and combinations thereof. The amount of aliphatic alcohol may be in a range between about 1 fold and about 10 fold of the amount of silicon dioxide present in the aqueous colloidal silica pre-dispersion. In some cases, stabilizers such as 4-hydroxy-2,2,6,6-tetramethylpiperidinyloxy (i.e. 4-hydroxy TEMPO) may be added to the pre-dispersion. In some instances, small amounts of acid or base may be added to adjust the pH of the transparent pre-dispersion. The resulting pre-dispersion may be heated in a range between about 50 degrees Celsius and about 100 degrees Celsius for a period in a range between about 1 hour and about 5 hours.

The cooled transparent organic pre-dispersion may be further treated to form a final dispersion of the compatibilized colloidal silica by addition of curable epoxy monomers or oligomers and optionally, more aliphatic solvent which may be selected from but not limited to isopropanol, 1-methoxy-2-propanol, 1-methoxy-2-propyl acetate, toluene, and combinations thereof. The final dispersion of the compatibilized colloidal silica may be treated with acid or base or with ion exchange resins to remove acidic or basic impurities. The final dispersion of the compatibilized colloidal silica may be concentrated under a vacuum in a range between about 0.5 mm Hg and about 250 mm Hg and at a temperature in a range between about 20 degrees Celsius and about 140 degrees Celsius to remove low boiling components such as solvent, residual water, and combinations thereof to give a transparent dispersion of compatibilized colloidal silica in a curable epoxy monomer, epoxy oligomer, or a combination thereof, herein referred to as a final concentrated dispersion. Removal of low boiling components may be defined herein as removal of at least about 90 percent of the total amount of low boiling components. The term “low boiling component” as used herein means a material having a boiling point less than about 200 degrees Celsius at about 1 atmosphere.

In some instances, the pre-dispersion or the final dispersion of the compatibilized colloidal silica may be further compatibilized. Low boiling components may be at least partially removed and subsequently, an appropriate capping agent that will react with residual hydroxyl functionality of the compatibilized colloidal silica may be added in an amount in a range between about 0.05 times and about 10 times the weight of silicon dioxide present in the pre-dispersion or final dispersion. Capping the compatibilized colloidal silica may improve the cure of the total curable epoxy formulation by improving room temperature stability of the epoxy formulation. Formulations that include the passivated compatibilized colloidal silica show much better room temperature stability than analogous formulations in which the colloidal silica has not been passivated.

Exemplary capping or passivating agents may include hydroxyl reactive materials such as silylating agents. Examples of a silylating agent include, but may be not limited to hexamethyldisilazane (“HMDZ”), tetramethyldisilazane, divinyltetramethyl disilazane, diphenyltetramethyldisilazane, N-(trimethylsilyl) diethylamine, 1-(trimethylsilyl) imidazole, trimethyl chlorosilane, pentamethyl chlorodisiloxane, pentamethyl disiloxane, and the like.

The transparent dispersion may be heated in a range between about 20° C. and about 140 degrees Celsius for a period of time in a range between about 0.5 hours and about 48 hours. The resultant mixture may be filtered. If the pre-dispersion was reacted with the capping agent, at least one curable epoxy monomer may be added to form the final dispersion. The mixture of the compatibilized colloidal silica in the curable monomer may be concentrated at a pressure in a range between about 0.5 mm Hg and about 250 mm Hg to form the final concentrated dispersion. During the process, low boiling components such as solvent, residual water, byproducts of the capping agent and hydroxyl groups, excess capping agent, and combinations thereof may be substantially removed.

A filled resin system according to embodiments of the invention may be produced by reacting a first portion of active termination sites of a plurality of particles with a functionalizing composition; and reacting a second portion of active termination sites of the plurality of particles with a passivating composition. Reacting the second portion of active termination sites may include capping or passivating active termination sites on a surface of each particle of the plurality to achieve less than about 10 active termination sites per square nanometer of surface area to stabilize the resin system. In one embodiment, the number of residual active termination sites may be less than about 6, less than about 5, less than about 4, or less than about 3.

The number of active termination sites remaining may be determined by the selection of filler material, the surface properties and any pretreatments of the filler material, the particle size of the filler material, the functionalizing or compatiblizing agent used, the passivating or capping agent used, the reaction parameters (length, temperature, pressure, and the like), and combinations of two or more thereof.

In one embodiment, the filler material may be prepared by capping or passivating prior to removal of a low boiling point solvent or fluid component. The low boiling point solvent or fluid component may be removed, at least partially, subsequent to the step of capping or passivating. In another embodiment, a refractory solid used as a filler material in a curable resin composition or adhesive system may have a relatively high stability or shelf life at a temperature that may be greater than room temperature, for example, at a temperature in a range of from about 30 degrees Celsius to about 50 degrees Celsius, 50 degrees Celsius to about 75 degrees Celsius, 75 degrees Celsius to about 100 degrees Celsius, or greater than about 100 degrees Celsius.

The resulting curable resin or resin blend (of a two-resin composition) contains compatibilized silicon dioxide particles. In such a case, the amount of silicon dioxide in the final composition may range from about 15 weight percent to about 80 weight percent of the final composition, from about 25 weight percent to about 75 weight percent, or from about 30 weight percent to about 70 weight percent of the final cured resin composition. The colloidal silica filler may be uniformly distributed throughout the disclosed composition, and the distribution remains stable at room temperature. As used herein “uniformly distributed” means the absence of any visible precipitate with such dispersions being transparent.

Suitable solvents for use with a resin (a single resin or a combination of resins) may include, for example, 1-methoxy-2-propanol, methoxy propanol acetate, butyl acetate, methoxyethyl ether, methanol, ethanol, isopropanol, ethyleneglycol, ethylcellosolve, methylethyl ketone, cyclohexanone, benzene, toluene, xylene, and cellosolves such as ethyl acetate, cellosolve acetate, butyl cellosolve acetate, carbitol acetate, and butyl carbitol acetate. These solvents may be used either singly or in the form of a combination of two or more members. In one embodiment, a solvent for use with the disclosure may be 1-methoxy-2-propanol. The solvent may be in the curable resin composition in an amount of from about 5 weight percent to about 70 weight percent, or about 15 weight percent to about 40 weight percent. Due to the addition of solvent, the first curable transparent resin may be sometimes referred to herein as a “solvent-modified resin,” and these terms may be used interchangeably.

In one embodiment, a first curable composition may include a resin matrix having at least one oxirane resin, a solvent, and a particle dispersion of compatibilized and passivated filler. The curable resin composition may have one or more hardeners, catalysts, or additives mixed therein. Upon heating and removal of solvent, the curable composition may form a transparent B-stage resin.

B-staging of the curable resin (in the case of a single-resin composition) or the resin blend (in the case of a composition comprising two resins) occurs at a temperature in a range of from about 50 degrees Celsius to about 250 degrees Celsius, more in a range of from about 70 degrees Celsius to about 100 degrees Celsius, in a vacuum at a pressure ranging of from about 25 mmHg to about 250 mmHg, or in a range of from about 100 mmHg to about 200 mmHg. In addition, B-staging may occur over a period of time in a range of from about 30 minutes to about 5 hours, and more in a range of from about 45 minutes to about 2.5 hours. Optionally, the B-staged resins may be post-cured at a temperature in a range of from about 100 degrees Celsius to about 250 degrees Celsius, more in range of from about 150 degrees Celsius to about 200 degrees Celsius over a period in a range of from about 45 minutes to about 3 hours.

Formulations that include compatibilized and passivated particles may show relatively better room temperature stability than analogous formulations in which colloidal silica has not been passivated. In some cases, increasing room temperature stability of the resin formulation may allow for higher loadings of curing agents, hardeners, and catalysts than might otherwise be desirable do to shelf life constraints. By increasing those loadings, a higher degree of cure, a lower cure temperature, or more sharply defined cure temperature profiles may be achievable.

Suitable passivating agents or capping agents may include hydroxyl reactive materials such as silylating agents. Examples of a silylating agent may include one or more of hexamethyl disilazane (“HMDZ”), tetramethyl disilazane, divinyl tetramethyl disilazane, diphenyl tetramethyl disilazane, N-(trimethylsilyl)diethylamine, 1-(trimethyl silyl)imidazole, trimethyl chlorosilane, pentamethyl chloro disiloxane, pentamethyl disiloxane, and the like. In one embodiment, hexamethyl disilazane may be used as the capping agent. Where the dispersion has been further compatibilized, e.g. by capping, at least one curable monomer may be added to form the final dispersion. The dispersion may be heated in a range of from about 20 degrees Celsius to about 140 degrees Celsius for a period of time in a range of from about 0.5 hours to about 48 hours. The resultant mixture may be filtered. The mixture of the compatibilized and passivated silica particles in the curable monomer may be concentrated at a pressure in a range of from about 0.5 Torr to about 250 Torr to form the final concentrated dispersion. During the process, lower boiling components such as solvent, residual water, byproducts of the capping agent and hydroxyl groups, excess capping agent, and combinations thereof may be substantially removed to give a dispersion of passivated compatibilized and passivated silica particles containing from about 15 weight percent to about 75 weight percent silica.

A hardener may be used. Suitable hardeners may include one or more of an amine epoxy hardener, a phenolic resin, a hydroxy aromatic compound, a carboxylic acid-anhydride, or a novolac hardener. In some embodiments, a difunctional siloxane anhydride may be used as an epoxy hardener, optionally in combination with at least one other hardener. Additionally, cure catalysts or organic compounds containing hydroxyl moiety may be optionally added with the epoxy hardener.

Exemplary amine epoxy hardeners may include aromatic amines, aliphatic amines, or combinations thereof. Aromatic amines may include, for example, m-phenylene diamine, 4,4′-methylenedianiline, diaminodiphenylsulfone, diaminodi-phenyl ether, toluene diamine, dianisidene, and blends of amines. Aliphatic amines may include, for example, ethyleneamines, cyclohexyldiamines, alkyl substituted diamines, menthane diamine, isophorone diamine, and hydrogenated versions of the aromatic diamines. Combinations of amine epoxy hardeners may be used.

Exemplary phenolic resins may include phenol-formaldehyde condensation products, commonly named novolac or cresol resins. These resins may be condensation products of different phenols with various molar ratios of formaldehyde. Such novolac resin hardeners may include those commercially available such as TAMANOL 758 or HRJ1583 oligomeric resins available from Arakawa Chemical Industries and Schenectady International, respectively.

Suitable hydroxy aromatic compounds may include, but may be not limited to, hydroquinone, resorcinol, catechol, methyl hydroquinone, methyl resorcinol and methyl catechol. If present, the hydroxy aromatic compounds may be present in an amount of from about 0.3 weight percent to about 0.5 weight percent, from about 0.5 to about 10 weight percent, or from about 10 weight percent to about 15 weight percent, or greater than 15 weight percent.

Suitable anhydride curing agents may include one or more of methyl hexa-hydrophthalic anhydride; methyl tetrahydrophthalic anhydride; 1,2-cyclohexanedicarboxylic anhydride; bicyclo(2.2.1)hept-5-ene-2,3-dicarboxylic anhydride; methyl bicyclo(2.2.1)hept-5-ene-2,3-dicarboxylic anhydride; phthalic anhydride; pyromellitic dianhydride; hexahydrophthalic anhydride; dodecenylsuccinic anhydride; dichloromaleic anhydride; chlorendic anhydride; tetrachlorophthalic anhydride; and the like. Combinations comprising at least two anhydride curing agents may be used. Anhydrides may hydrolyze to carboxylic acids useful for fluxing.

Suitable anhydrides may include those of the following formula (IV): 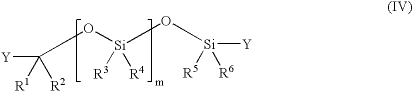
where “m” is an integer in a range of from 0 to about 50 inclusive, and each R1, R2, R3, R4, R5 and R6 are independently a C₁₋₂₂ alkyl, C₁₋₂₂ alkoxy, C₁₋₂₂ alkenyl, C₆₋₁₄ aryl, C₆₋₂₂ alkyl-substituted aryl, and C₆₋₂₂ arylalkyl. In one embodiment, “n” is in a range of from about 1 to about 10, from about 10 to about 25, from about 25 to about 40, from about 40 to about 50, or greater than about 50. Each R1, R2, R3, R4, R5 and R6 may be halogenated, such as fluorinated or chlorinated. In one embodiment, one or more of R1, R2, R3, R4, R5 and R6 may be methyl, ethyl, propyl, 3,3,3-trifluoropropyl, isopropyl, or phenyl.

Suitable difunctional siloxane anhydrides may have the following structural formula (V): 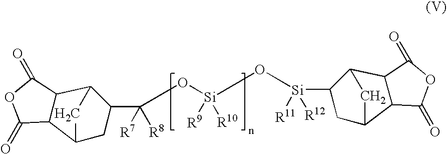
where “n” is an integer in a range of from 0 to about 50 inclusive, and each R7, R8, R9, R10, R11 and R12 are independently a C₁₋₂₂ alkyl, C₁₋₂₂ alkoxy, C₂₋₂₂ alkenyl, C₆₋₁₄ aryl, C₆₋₂₂ alkyl-substituted aryl, and C₆₋₂₂ arylalkyl. In one embodiment, “n” is in a range of from about 1 to about 10, from about 10 to about 25, from about 25 to about 40, from about 40 to about 50, or greater than about 50. Each R7, R8, R9, R10, R11 and R12 are may be halogenated, such as fluorinated or chlorinated. In one embodiment, one or more of R7, R8, R9, R10, R11 and R12 are may be one or more of methyl, ethyl, propyl, 3,3,3-trifluoropropyl, isopropyl, or phenyl.

Suitable difunctional siloxane anhydrides may have the following structural formula (VI): 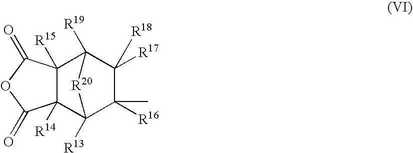
where R13-R19 may be hydrogen, halogen, C1 or greater monovalent hydrocarbon radicals, and substituted C1 or greater hydrocarbon radicals, and R20 may be oxygen or C-R21, wherein R21 is any two selected from hydrogen, halogen, C1 or greater monovalent hydrocarbon radicals, and substituted C1 or greater hydrocarbon radicals.

In one embodiment, the oligosiloxane dianhydride of the disclosure may be synthesized by hydrosilation of 1 mole of 1,1,3,3,5,5-hexamethyltrisiloxane with two moles of 5-norbomene-2,3-dicarboxylic anhydride in the presence of Karstedt's platinum catalyst (the complex of Pt⁰ with divinyltetramethyldisiloxane). A suitable difunctional siloxane anhydride may include 5,5′-(1,1,3,3,5,5-hexamethyl-1,5-trisiloxanediyl) bis(hexahydro-4,7-methanoisobenzofuran-1,3-dione).

Cure catalysts which may be added to form the epoxy formulation may be selected from epoxy curing catalysts that may include but may be not limited to amines, alkyl-substituted imidazole, imidazolium salts, phosphines, metal salts such as aluminum acetyl acetonate (Al(acac)3), salts of nitrogen-containing compounds with acidic compounds, and combinations thereof. The nitrogen-containing compounds may include, for example, amine compounds, di-aza compounds, tri-aza compounds, polyamine compounds and combinations thereof. The acidic compounds may include phenol, organo-substituted phenols, carboxylic acids, sulfonic acids and combinations thereof. A suitable catalyst may be a salt of nitrogen-containing compounds. Salts of nitrogen-containing compounds may include, for example 1,8-diazabicyclo(5,4,0)-7-undecane. The salts of the nitrogen-containing compounds may be available commercially, for example, as Polycat SA-1 and POLYCAT SA-102 available from Air Products. A catalyst may include one or more of triphenyl phosphine (TPP), N-methylimidazole (NMI), and dibutyl tin dilaurate (DiBSn).

In one embodiment, the second curable fluxing resin may include a difunctional siloxane anhydride as described above which, in some cases, may be combined with another epoxy hardener such as an amine epoxy hardener, a phenolic resin, a carboxylic acid-anhydride, or a novolac hardener as described above. In some embodiments, the difunctional siloxane anhydride may be miscible with liquid carboxylic acid-anhydrides. The difunctional siloxane anhydride may be blended with a carboxylic acid-anhydride to form a liquid solution. In these embodiments, the epoxy hardener may include a difunctional siloxane anhydride in combination with a liquid organic anhydride such as hexahydrophthalic anhydride, MHHPA, or tetrahydrophthalic anhydride.

Where utilized, the difunctional siloxane anhydrides may be may included in the hardener component of the second curable fluxing resin composition in amounts in a range of from about 1 weight percent to about 100 weight percent of the hardener component of the second curable fluxing resin composition. The component may be present in an amount in a range of from about 10 weight percent to about 40 weight percent, or from about 40 weight percent to about 90 weight percent.

Where utilized, the carboxylic acid-anhydrides may include the hardener component of the second curable fluxing resin composition in amounts in a range of from about 1 weight percent to about 10 weight percent, from about 10 weight percent to about 50 weight percent being, from about 50 weight percent to about 75 weight percent, or from about 75 weight percent to about 90 weight percent of the hardener component of the composition.

A cure catalyst may be added to the concentrated dispersion. The cure catalyst may be capable of accelerating curing of the total curable epoxy formulation. The catalyst may be present in an amount in a range of from about 10 parts per million (ppm) up to about 10 weight percent of the total curable epoxy formulation. Suitable cure catalysts may include onium catalysts such as bisaryliodonium salts and/or triarylsulphonium salts. A suitable bisaryliodonium salts may include one or more of bis(dodecylphenyl) iodonium hexafluoro antimonate; (octyloxyphenyl, phenyl) iodonium hexafluoro antimonate; or bisaryliodonium tetrakis(pentafluoro phenyl)borate. Optionally, an effective amount of a free-radical generating compound can be added as a reagent. A suitable free-radical generating compound may include one or more aromatic pinacols, benzoinalkyl ethers, organic peroxides, and combinations of two or more thereof. The free radical generating compound may facilitate decomposition of onium salt at a relatively lower temperature.

Cure catalysts may include one or more amines, alkyl-substituted imidazoles, imidazolium salts, phosphines, metal salts such as aluminum acetyl acetonate (A1(acac)3), salts of nitrogen-containing compounds with acidic compounds, and combinations of two or more thereof. Suitable nitrogen-containing compounds may include amine compounds, di-aza compounds, tri-aza compounds, polyamine compounds, and the like. The acid compounds may include phenol, organo-substituted phenols, carboxylic acids, sulfonic acids, and the like. A suitable catalyst may be a salt of a nitrogen-containing compound. One such salt includes, for example, 1,8-diazabicyclo{5,4,0}-7-undecane. The salts of the nitrogen-containing compounds may be commercially available, for example, as POLYCAT SA-1 and POLYCAT SA-102 from Air Products, Inc. Other Suitable catalysts may include triphenyl phosphine (PPh3) and alkyl-imidazole.

Optionally, an epoxy hardener such as carboxylic acid-anhydride curing agents and an organic compound containing hydroxyl moiety may be present as optional reagents with the cure catalyst. In these cases, cure catalysts may be selected from curing catalysts that may include amines, alkyl-substituted imidazole, imidazolium salts, phosphines, metal salts, and the like. A suitable catalyst may be triphenyl phosphine, alkyl-imidazole, or aluminum acetyl acetonate.

Exemplary anhydride curing agents include methylhexahydrophthalic anhydride (“MHHPA”), 1,2-cyclohexanedicarboxylic anhydride, bicyclo{2.2.1} hept-5-ene-2,3-dicarboxylic anhydride, methylbicyclo{2.2.1}hept-5-ene-2,3-dicarboxylic anhydride, phthalic anhydride, pyromellitic dianhydride, hexahydrophthalic anhydride, dodecenylsuccinic anhydride, dichloromaleic anhydride, chlorendic anhydride, tetrachlorophthalic anhydride, and the like. Combinations comprising at least two anhydride curing agents may be used.

Examples of organic compounds utilized as the hydroxyl-containing moiety may include alcohols such as diols, high boiling alkyl alcohols containing one or more hydroxyl groups and bisphenols. The alkyl alcohols may be straight chain, branched or cycloaliphatic and may contain from 2 to 12 carbon atoms. Examples of such alcohols may include but may be not limited to ethylene glycol; propylene glycol, i.e., 1,2- and 1,3-propylene glycol; 2,2-dimethyl-1,3-propane diol; 2-ethyl, 2-methyl, 1,3-propane diol; 1,3- and 1,5-pentane diol; dipropylene glycol; 2-methyl-1,5-pentane diol; 1,6-hexane diol; dimethanol decalin, dimethanol bicyclo octane; 1,4-cyclohexane dimethanol and particularly its cis- and trans-isomers; triethylene glycol; 1,10-decane diol; and combinations of any of the foregoing. Further examples of alcohols may include 3-ethyl-3-hydroxymethyl-oxetane (commercially available as UVR6000 from Dow Chemical) and bisphenols.

Suitable dihydroxy-substituted aromatic compounds may include 4,4′-(3,3,5-trimethylcyclohexylidene)-diphenol; 2,2-bis(4-hydroxyphenyl)propane (known as bisphenol A); 2,2-bis(4-hydroxyphenyl) methane (known as bisphenol F); 2,2-bis(4-hydroxy-3,5-dimethylphenyl)propane; 2,4′-dihydroxy diphenyl methane; bis(2-hydroxyphenyl)methane; bis(4-hydroxyphenyl)methane; bis(4-hydroxy-5-nitrophenyl)methane; bis(4-hydroxy-2,6-dimethyl-3-methoxyphenyl)methane; 1,1-bis(4-hydroxyphenyl)ethane; 1,1-bis(4-hydroxy-2-chlorophenyl ethane; 2,2-bis(3-phenyl-4-hydroxyphenyl)propane; bis(4-hydroxyphenyl)cyclohexyl methane; 2,2-bis(4-hydroxyphenyl)-1-phenylpropane; 2,2,2′,2′-tetrahydro-3,3,3′,3′-tetramethyl, 1′-spirobi(1H-indene)-6,6′-diol(“SBI”); 2,2-bis(4-hydroxy-3-methylphenyl)propane (known as “DMBPC”); and C₁₋₁₃ alkyl-substituted resorcinols. Combinations of organic compounds containing one or more hydroxyl moiety may be used.

A reactive organic diluent may be added to the total curable epoxy formulation to decrease the viscosity of the composition. Examples of reactive diluents may include 3-ethyl-3-hydroxymethyl oxetane; dodecylglycidyl; 4-vinyl-1-cyclohexane diepoxide; di(beta-(3,4-epoxycyclohexyl) ethyl)tetramethyldisiloxane; and the like. Reactive organic diluents may include monofunctional epoxies and/or compounds containing at least one epoxy functionality. Representative examples of such diluents may include, but may be not limited to, alkyl derivatives of phenol glycidyl ethers such as 3-(2-nonylphenyloxy)-1,2-epoxypropane or 3-(4-nonylphenyloxy)-1,2-epoxypropane. Other diluents which may be used may include glycidyl ethers of phenol itself and substituted phenols such as 2-methylphenol, 4-methyl phenol, 3-methylphenol, 2-butylphenol, 4-butylphenol, 3-octylphenol, 4-octylphenol, 4-t-butylphenol, 4-phenylphenol and 4-(phenyl isopropylidene)phenol.

Adhesion promoters may be employed with the first curable resin such as trialkoxyorganosilanes (e.g., γ-aminopropyltrimethoxysilane, 3-glycidoxypro-pyltrimethoxysilane, and bis(trimethoxysilylpropyl)fumarate). If present, the adhesion promoters may be added in an effective amount. An effective amount may be in a range of from about 0.01 weight percent to about 2 weight percent of the total final dispersion.

Optionally, micrometer-size fused silica filler may be added. When present, the fused silica fillers may be added in an effective amount to provide further reduction in CTE, as spacers to control bond-line thickness, and the like.

Flame retardants may be optionally used. When present, the flame retardant may be in a range of from about 0.5 weight percent to about 20 weight percent relative to the total weight. Suitable flame retardants may include one or more phosphoramides, triphenyl phosphate (TPP), resorcinol diphosphate (RDP), bisphenol-a-disphosphate (BPA-DP), organic phosphine oxides, halogenated epoxy resin (tetrabromobisphenol A), metal oxide, metal hydroxides, and combinations of two or more thereof.

Suitable additives may be selected with reference to performance requirements for particular applications. For example, a fire retardant additive may be selected where fire retardancy may be desired, a flow modifier may be employed to affect rheology or thixotropy, a thermally conductive material may be added where thermal conductivity may be desired, and the like.

A suitable amount of solid in the adhesive system may be greater than about 1 weight percent or less than about 99 weight percent. In one embodiment, the solid may be present in an amount sufficient to about match a coefficient of thermal expansion of the adhesive composition to a chip selected for use with the adhesive system. In one embodiment, the solid may be present in the adhesive system in a range of from about 5 weight percent to about 25 weight percent, from about 25 weight percent to about 35 weight percent, from about 35 weight percent, to about 45 weight percent, from about 45 weight percent to about 55 weight percent, from about 55 weight percent to about 65 weight percent, or greater than about 65 weight percent.

Because of factors, such as filler amount, the coefficient of thermal expansion of the adhesive composition, after cure, may be selected to be less than about 50 ppm/degree Celsius, less than about 40 ppm/degree Celsius, or less than about 30 ppm/degree Celsius. In one embodiment, the coefficient of thermal expansion may be in a range of from about 10 ppm/degree Celsius to about 20 ppm/degree Celsius, from about 20 ppm/degree Celsius to about 30 ppm/degree Celsius, from about 30 ppm/degree Celsius to about 40 ppm/degree Celsius, or greater than about 40 ppm/degree Celsius. In one embodiment, a glass transition temperature of the adhesive composition, after cure, may be greater than about 150 degrees Celsius, greater than about 200 degrees Celsius, greater than about 250 degrees Celsius, greater than about 300 degrees Celsius, or greater than about 350 degrees Celsius.

A reactive organic diluent may be added to the total curable epoxy formulation to decrease the viscosity of the composition. Examples of reactive diluents may include one or more of 3-ethyl-3-hydroxymethyl oxetane; dodecyl glycidyl ether; 4-vinyl-1-cyclohexane diepoxide; di(Beta-(3,4-epoxy cyclohexyl)ethyl)-tetramethyl disiloxane; and combinations thereof. An unreactive diluent may be added to the composition to decrease the viscosity of the formulation. Examples of unreactive diluants include, but may be not limited to toluene, ethylacetate, butyl acetate, 1-methoxy propyl acetate, ethylene glycol, dimethyl ether, and combinations thereof. The total curable epoxy formulation can be blended with a filler which can include, for example, fumed silica, fused silica such as spherical fused silica, alumina, carbon black, graphite, silver, gold, aluminum, mica, titania, diamond, silicone carbide, aluminum hydrates, boron nitride, and combinations thereof. When present, the filler may be present in a range between about 10 weight percent and about 95 weight percent, based on the weight of the total epoxy curable formulation. More, the filler may be present in a range between about 20 weight percent and about 85 weight percent, based on the weight of the total curable epoxy formulation.

Adhesion promoters can also be employed with the total curable epoxy formulation such as trialkoxy organosilanes (e.g., amino propyl trimethoxy silane; 3-glycidoxy propyltrimethoxy silane; bis(trimethoxysilylpropyl) fumarate); and combinations thereof used in an effective amount. An effective amount may be in a range of greater than about 0.01 weight percent, from about 0.01 weight percent to about 2 weight percent, or more than about 2 weight percent of the total curable epoxy formulation.

Flame retardants may optionally be used in the total curable epoxy formulation of the invention in a range between about 0.5 weight percent and about 20 weight percent relative to the amount of the total curable epoxy formulation. Examples of flame retardants in the invention include phosphoramides, triphenyl phosphate (“TPP”), resorcinol diphosphate (“RDP”), bisphenol-a-disphosphate (“BPA-DP”), organic phosphine oxides, halogenated epoxy resin (tetrabromobisphenol A), metal oxide, metal hydroxides, and combinations thereof.

Defoaming agents, dyes, pigments, and the like can also be incorporated into the total curable epoxy formulation. The amount of such additives may be determined by the end-use application.

Methods for producing the compositions of the disclosure result in relatively improved underfill materials. For the first curable resin composition, in one embodiment compositions may be prepared by functionalizing colloidal silica such that a stable concentrated dispersion of colloidal silica may be formed; forming a concentrated dispersion of compatibilized and passivated silica particles containing about 15 weight percent to about 75 weight percent silica; blending solutions of epoxy monomers including at least aromatic epoxy resin optionally in combination with cycloaliphatic epoxy monomers, aliphatic epoxy monomers, and/or hydroxy aromatic compounds, and optionally one or more additives such as hardeners, catalysts or other additives described above, and at least one solvent with the compatibilized and passivated silica particles dispersion; and removing the solvent to form a hard, transparent B-stage resin film.

The second curable fluxing resin composition may be similarly prepared. In one embodiment, second curable fluxing resin compositions may be prepared by blending solutions of epoxy monomers and optionally one or more additives such as hardeners, catalysts or other additives described above. In some cases, the second fluxing resin may include compatibilized and passivated silica particles dispersion as a filler and may be prepared in the same manner as the compatibilized and passivated silica particles dispersion utilized in the first solvent-modified resin. In other embodiments, the second fluxing resin does not may include a compatibilized and passivated silica particles dispersion as a filler.

The composition may by hand mixed but also can be mixed by mixing equipment such as dough mixers, chain can mixers, planetary mixers, twin screw extruder, two or three roll mill and the like. The blending can be performed in batch, continuous, or semi-continuous mode. With a batch mode reaction, for instance, all of the reactant components may be combined and reacted until most of the reactants may be consumed. In order to proceed, the reaction has to be stopped and additional reactant added. With continuous conditions, the reaction does not have to be stopped in order to add more reactants.

In one embodiment, an uncured underfill composition may have a viscosity before cure in a range of from less than about 50 centipoise, from about 50 centipoise to about 1,000 centipoise, from about 1,000 centipoise to about 10,000 centipoise, from about 10,000 centipoise to about 20,000 centipoise at about room temperature before the composition may be cured. Viscosity may be measured by a Brookfield viscometer or the like.

Curing the B-stage resin film in combination with the second fluxing resin may be useful in forming a low CTE, high glass transition temperature thermoset resin for use as an underfill material.

In one embodiment, a combination of resin materials may be useful as an underfill material. The underfill material may include two or more resins: a first curable transparent resin composition, and a second curable fluxing resin composition. The first curable resin composition may be applied at the wafer stage, and forms a hard, transparent B-stage resin upon solvent removal. The wafer may be subjected to dicing or similar operations to produce individual chips. However, in some embodiments the first curable resin may be applied to an individual chip after dicing. The second curable fluxing resin may be applied to the substrate or device to which the chip may be to be applied. The second curable fluxing resin may secure the chip in place during a reflow operation to limit motion by, or misalignment of, the chip.

The wafer level underfilling process may include dispensing underfill materials onto the wafer, followed by removal of solvent to form a solid, transparent B-stage resin before dicing into individual chips that may be subsequently mounted in the final structure via flip-chip type operations.

The second curable fluxing resin may be applied to a substrate as a no-flow underfil. The process generally may include first dispensing the second resin material onto a substrate or semiconductor device, placing a flip chip coated with the solvent-modified resin of the disclosure on top of the fluxing resin, and performing a solder bump reflow operation to simultaneously form solder joints and cure the two resin compositions which make up the underfill material. The combined resins thus act as an encapsulant material between chip and substrate.

Two resin compositions of the disclosure may be utilized as follows. The first solvent-modified resin may be applied to a wafer or chip and cured as described above to form a B-stage resin. If the first solvent-modified resin has been applied as wafer level underfill, it may be subjected to dicing or a similar operation after formation of the B-stage resin to produce individual chips.

Underfill materials may be dispensable and have utility in devices such as solid-state devices and/or electronic devices such as computers or semiconductors, or a device where underfill, overmold, or combinations thereof may be needed. The underfill material may be used as an adhesive, for example, to reinforce physical, mechanical, and electrical properties of solder bumps that connect a chip and a substrate.

Once the chips have been prepared, the second fluxing resin may be applied to a substrate. The second fluxing resin of the disclosure may be dispensed using a needle in a dot pattern in the center of a component footprint area. The amount of second fluxing resin may be carefully controlled to avoid the phenomenon known as “chip-floating”, which results from dispensing an excess of the fluxing resin. The flip-chip die coated with the solvent-modified resin that has been B-staged may be placed on top of the dispensed second fluxing resin using an automatic pick and place machine. The placement force as well as the placement head dwell time may be controlled to optimize cycle time and yield of the process.

The construction may be heated to melt solder balls, form solder interconnects and cure the B-stage resin in combination with the fluxing resin. The heating operation usually may be performed on the conveyor in the reflow oven. The underfill may be cured by two significantly different reflow profiles. The first profile may be referred to as the “plateau” profile, which may include a soak zone below the melting point of the solder. The second profile, referred to as the “volcano” profile, raises the temperature at a constant heating rate until the maximum temperature may be reached. A temperature ceiling during a cure cycle may be in a range of from about 200 degrees Celsius to about 260 degrees Celsius.

The temperature during the reflow may depend on solder composition and may be about 10 degrees Celsius to about 40 degrees Celsius higher than the melting point of the solder balls. The heating cycle may be of from about 3 minutes to about 10 minutes, and more may be from about 4 minutes to about 6 minutes. The underfill may cure completely after the solder joints may be formed or may require additional post-cure. Optionally, post-curing may occur at a temperature in a range of from about 100 degrees Celsius to about 140 degrees Celsius, from about 140 degrees Celsius to a bout 160 degrees Celsius, from about 160 degrees Celsius to about 180 degrees Celsius, or greater than about 180 degrees Celsius, for less than about 1 hour, or over a period in a range of from about 1 hour to about 4 hours.

Thus, the use of a first solvent-modified epoxy resin may be useful in producing B-stage resin films, and once combined with a second fluxing resin, curing the combination of the two resins may be useful to produce low CTE, high glass transition temperature thermoset resins. The transparency of the B-stage resin films, and cured films, formed from the curable composition makes them suitable as wafer level underfill materials. Suitable transparency is defined as being capable of transmitting sufficient light so as to not obscure guide marks used for wafer dicing. The transparency of the cured film is in a range of greater than about 50 percent visible light transmission, in a range of from about 50 percent to about 75 percent, from about 75 percent to about 85 percent, from about 85 percent to about 90 percent, or greater than about 90 percent visible light transmission. In one embodiment, the transparency may be measured with reference to light in a wavelength outside of the visible spectrum. In such an embodiment, the light transmission may be sufficient to allow a detector or sensor to discern guide marks for wafer dicing.

The second fluxing resin may hold the chip to which the first solvent-modified resin has been applied in place during reflow operations. Moreover, by following the methods of the disclosure, where the second fluxing resin may be unfilled, one may obtain a graded underfill material with the CTE of the material decreasing from the substrate toward the chip.

Underfill materials according to embodiments of the invention may exhibit one or more of enhanced performance, have economic advantage, or allow solder joints to form before the underfill material reaches a gel point. An adhesive composition according to one embodiment may fill gaps between a chip and a substrate having a depth in a range of from about 30 nanometers to about 500 micrometers. In one embodiment, a coefficient of thermal expansion of a cured adhesive composition may be less than about 50 parts per million per degree centigrade (ppm/C), less than about 40 ppm/C, or less than 30 ppm/C. The CTE may be tailored by affecting the underfill composition makeup and cure to reflect end-use requirements.

The addition of the compatibilized colloidal silica to an epoxy resin composition containing hydroxyl monomers and an anhydride in accordance with the present disclosure has been unexpectedly found to provide good solder ball fluxing which, in combination with the large reduction in CTE, can not be achieved with a conventional micrometer-sized fused silica. The resulting composition self-fluxes insofar as acidic species may be generated during cure. The presence of such acidic species may facilitate solder ball cleaning and joint formation of determined properties.

Formulations may be dispensable and have utility in devices in electronics such as computers, semiconductors, or any device where underfill, overmold, or combinations thereof may be needed. Dispensable refers to rheological properties and flow characteristics, such as void formation, that are determined by the particular manufacturing industry. Underfill encapsulant may be used to reinforce physical, mechanical, and electrical properties of solder bumps that connect a chip and a substrate. Underfilling may be achieved by any method known in the art. The conventional method of underfilling includes dispensing the underfill material in a fillet or bead extending along two or more edges of the chip and allowing the underfill material to flow by capillary action under the chip to fill all the gaps between the chip and the substrate. Other exemplary methods include no-flow underfill, transfer molded underfill, wafer level underfill, and the like. The process of no-flow underfilling includes first dispensing the underfill encapsulant material on the substrate or semiconductor device and second performing the solder bump reflowing and underfill encapsulant curing simultaneously. The process of transfer molded underfilling includes placing a chip and substrate within a mold cavity and pressing the underfill material into the mold cavity. Pressing the underfill material fills the air spaces between the chip and substrate with the underfi material. The wafer level underfilling process includes dispensing underfill materials onto the wafer before dicing into individual chips that may be subsequently mounted in the final structure via flip-chip type operations. The material has the ability to fill gaps in a range between about 30 microns and about 500 microns.

Thus, molding material to form the encapsulant may be poured or injected into a mold form in a manner optimizing environmental conditions such as temperature, atmosphere, voltage, and pressure, to minimize voids, stresses, shrinkage and other potential defects. Molding of the encapsulant may be performed in a vacuum at a processing temperature up to about 300 degrees Celsius. After molding, the encapsulant may be cured via methods such as thermal cure, UV light cure, microwave cure, or the like. Curing occurs at a temperature in a range of from about 50 degrees Celsius to about 120 degrees Celsius, or in a range of from about 120 degrees Celsius to about 250 degrees Celsius, at a pressure in a range between about 1 atmosphere (atm) to about 1000 pounds per square inch (psi), or in a range between about 1000 pounds per square inch to about 5 tons pressure per square inch. Curing may occur over a period in a range between about 30 seconds to about 90 seconds, from about 90 seconds to about 30 minutes, or longer. Optionally, the cured encapsulants can be post-cured at a temperature in a range between about 150 degrees Celsius to about 175 degrees Celsius, or in range between about 175 degrees Celsius to about 200 degrees Celsius over a period in a range between about 1 hour to about 4 hours.

The process of no-flow underfilling includes first dispensing the underfill encapsulant material on the substrate or semiconductor device and second placing a flip chip on the top of the encapsulant and third performing the solder bump reflow to form solder joints and cure underfill encapsulant simultaneously. The material has the ability to fill gaps in a range between about 30 micrometers and about 250 micrometers.

A packaged solid state device may be provided which includes a package, a chip, and an encapsulant comprising the underfill compositions of the present disclosure. In such a case, the encapsulant may be introduced to the chip by processes including capillary underfill, no-flow underfill, and the like. Chips that may be packaged using the underfill composition include semiconductor chips and LED chips.

As noted herein, an underfill composition may encapsulate at least a portion of a chip interconnect. The underfill may be dispensed using a needle in a dot pattern in the center of the component footprint area. Other suitable dispensing methods may include a jetting method—dots on the fly or line mode—and a DJ-9000 DispenseJet, which is commercially available from Asymtek (Carlsbad, Calif.). Controlling the amount of no-flow underfill may achieve a determined fillet size, and may reduce or minimize chip-floating. Chip floating may result from dispensing an excess of the no-flow underfill. The flip-chip die may be placed on the top of the dispensed no-flow underfill using an automatic pick and place machine. The placement force as well as the placement head dwell time may be controlled to optimize cycle time and yield of the process. The construction may be heated to melt solder balls, form solder interconnect and finally cure the underfill resin. The heating operation usually may be performed on the conveyor in the reflow oven. The cure kinetics of the no-flow underfill has to be tuned to fit a temperature profile of the reflow cycle. The no-flow underfill has to allow the solder joint formation before the encapsulant reaches a gel point but it has to form a solid encapsulant at the end of the heat cycle.

In manufacturing flip-chip devices, the no-flow underfill may be cured by at least two significantly different reflow profiles. The first profile may be referred to as the “plateau” profile, which includes a soak zone below the melting point of the solder. The second profile, referred to as the “volcano” profile, raises the temperature at a constant heating rate until the maximum temperature may be reached. The maximum temperature during a cure cycle can range from about 200 degrees Celsius to about 260 degrees Celsius. The maximum temperature during the reflow strongly depends on the solder composition and has to be about 10 degrees Celsius to about 40 degrees Celsius higher than the melting point of the solder balls. The heating cycle may be between about 3 minutes to about 5 minutes, or from about 5 to about 10 minutes. Optionally, the cured encapsulants may be post-cured at a temperature in a range of from about 100 degrees Celsius to about 140 degrees Celsius, or from about 140 degrees Celsius to about 160 degrees Celsius, over a period of time in a range of from about 1 hour to about 4 hours.

A suitable epoxy resin may be an epoxy derived from novolac cresol resin and a particle filler dispersion, which may include compatibilized and passivated silica particles in an aqueous media. The curable resin composition may include one or more hardeners and/or catalysts, among other additives. Upon heating and removal of solvent, the combination forms a transparent B-stage resin. In one embodiment, a curable resin compositions that may be useful as underfill materials, which may be applicable in the flip chip technology. After removal of the solvent, the underfill materials may be finally curable by heating to a transparent B-stage, cured, hard resin with a low CTE, and high glass transition temperature. The colloidal silica filler may be uniformly distributed throughout the disclosed compositions that contain a solvent, and the distribution may remain stable at room temperature and during removal of solvent and any curing steps. The resin transparency of the resulting resin may be useful as an underfill material, especially a wafer level underfill, for wafer dicing operations to render wafer dicing guide marks visible during wafer dicing operations. The disclosed compositions may be a useful underfill as, for example, a wafer level underfill. In certain embodiments, the underfill material may have self-fluxing capabilities.

An electronic device may be formed by assembling a chip to a substrate using the adhesive composition. A suitable chip may include a semiconductor material, such as silicon, gallium, germanium or indium, or combinations of two or more thereof.

### EXAMPLES

The following examples may illustrate methods and embodiments in accordance with the invention, and as such should not be construed as imposing limitations upon the claims. Unless specified otherwise, all ingredients may be commercially available from such common chemical suppliers as Alpha Aesar, Inc. (Ward Hill, Mass.), Spectrum Chemical Mfg. Corp. (Gardena, Calif.), and the like.

### Example 1

### Preparation of Compatibilized and Passivated Silica Particle Predispersion

A compatibilized and passivated silica particle predispersion is prepared by combining the following: 935 grams of isopropanol is slowly added while stirring to 675 grams of aqueous colloidal silica containing 34 weight percent of silica particles having an average diameter of 20 nanometers. Subsequently, 58.5 grams phenyl trimethoxysilane (PTS) are dissolved in 100 grams isopropanol, and are added to the stirred mixture. The mixture is heated to 80 degrees Celsius for 1-2 hours to afford a transparent suspension. The resulting suspension of compatibilized and passivated silica particles is stored at room temperature. Multiple dispersions, having various levels of silica (from 10 weight percent to 30 weight percent) are prepared for use in Example 2.

### Example 2

### Preparation of a Composition of a Curable Resin and Compatibilized and Passivated Silica Particles

A round bottom 2000 ml flask is charged with 540 grams of each of the pre-dispersions, prepared in Example 1. Additional pre-dispersion compositions may be shown in Table 1, below. 1-methoxy-2-propanol (750 grams) is added to each flask. The resulting dispersion of compatibilized and passivated silica particles is vacuum stripped at 60 degrees Celsius and 60 mmHg to remove about 1 liter (L) of solvent. The vacuum is slowly decreased and solvent removal continued with good agitation until the dispersion weight reaches 140 grams. The transparent dispersion may include compatibilized and passivated silica particles at about 50 weight percent silica, and may have no hydrophilic precipitated silica. The dispersion is stable at room temperature for more than three months. The results in Table 1 show that a cartain level of phenyl functionality may be useful to prepare a concentrated, stable compatibilized and passivated silica particle dispersion in 1-methoxy-2-propanol Samples 1-5). The functionality level may be adjusted to achieve a transparent, stable dispersion in methoxypropanol acetate. The adjustment indicates that optimization of functionality level permitted dispersions to be prepared in other solvants (Samples 6 and 7).

TABLE 1
Preparation of compatibilized and passivated silica particle dispersions.

| | | Final Dispersion | |
|---|---|---|---|
| | | Concentration | |
| | | (weight percent | |
| | Pre-dispersion | silica)/ | |
| | Composition | (weight percent | Dispersion Stability |
| Sample | (PTS*/100 g silica) | total solids) | (in methoxypropanol) |
| 1 | 0.028 m/100 g | 50/63 | Precipitated |
| 2 | 0.056 m/100 g | 47/60 | Precipitated |
| 3 | 0.13 m/100 g | 53/66 | stable, transparent |
| 4 | 0.13 m/100 g | 60/75 | stable, transparent |
| 5 | 0.19 m/100 g | 50/63 | stable, transparent |
| | | (in methoxy propanol acetate) | |
| 6 | 0.13 m/100 g | 50/63 | Precipitated |
| 7 | 0.19 m/100 g | 50/63 | stable, transparent |

*PTS is phenyltrimethoxysilane

### Example 3

### Preparation of a Composition of a Curable Resin and Compatibilized and Passivated Silica Particles

A solution combining 5.33 grams of epoxy cresol novolac (ECN 195XL-25 available from Sumitomo Chemical Co.), 2.6 grams of novolac hardener (TAMANOL 758 available from Arakawa Chemical Industries) in 3.0 grams of 1-methoxy-2-propanol is heated to about 50 degrees Celsius. A 7.28 gram portion of the solution is added, dropwise, to 10.0 grams of Sample 3 while stirring at 50 degrees Celsius. The transparent suspension is cooled. A catalyst solution of N-methylimidazole in methoxypropanol, 60 microliters of a 50 weight percent (w/w) solution, is added while stirring. The transparent solution is solvent cast into resin films for characterization, and some of the solution is stored at −10 degrees Celsius. Other films are prepared using differing catalysts in various amounts and with some variations in epoxy-type as set forth in Table 2 below.

Films are cast by spreading a portion of the epoxy-silica dispersion on glass plates, and the solvent is removed in an oven set at 85 degrees Celsius under a vacuum of 150 mmHg. After 1-2 hours, the glass plates are removed and the film remaining is transparent and hard. In some cases, the dry film is cured at 220 degrees Celsius for 5 minutes followed by heating at 160 degrees Celsius for 60 minutes. Glass transition temperature measurements are obtained by Differential Scanning Calorimetry using a commercially available DSC from Perkin Elmer. The formulations tested and glass transition temperature are set forth below in Table 2.

TABLE 2
Formulations (Types are in listed; units are in parenthetical and in grams).

| Sample | Curable resin* | Hardener** | Solvent*** | Catalyst**** | Silica***** | Tg****** |
|---|---|---|---|---|---|---|
| 8 | ECN (3.55) | T758 (1.73) | MeOPrOH (2) | TPP (0.12) | (10) | 168 |
| 9 | ECN (3.55) | T758 (1.73) | MeOPrOH (2) | TPP (0.06) | (10) | 165 |
| 10 | ECN (3.55) | T758 (1.73) | MeOPrOH (2) | NMI(0.015) | (10) | 199 |
| 11 | ECN (3.55) | T758 (1.73) | MeOPrOH (2) | NMI(0.018) | (5) | 180 |
| 12 | ECN (3.55) | T758 (1.73) | MeOPrOH (2) | TPP (0.06) | (10) | 136 |
| | Epon 1002F (0.5) | | | | | |
| 13 | ECN (3.55) | T758 (1.73) | MeOPrOH (2) | NMI(0.03) | (10) | 184 |
| | Epon 1002F (0.5) | | | | | |
| 14 | ECN (3.55) | T758 (1.73) | BuAc (2) | TPP (0.12) | (5) | 171 |
| 15 | ECN (3.55) | T758 (1.73) | Diglyme (2) | TPP (0.12) | (5) | 171 |
| 16 | ECN (3.55) | T758 (1.73) | BuAc (2) | DiBSn (0.12) | (5) | 104 |

*ECN refers to ECN 195XL-25 available form Sumitomo Chemical Co. and Epon 1002F refers to an oligomerized BPA diglycidyl ether epoxy available from Resolution Performance Products.
**T758 refers to TAMANOL 758 available from Arakawa Chemical Industries
***1-methoxy-2-propanol(MeOPrOH), butyl acetate (BuAc), and methoxyethyl ether (diglyme)
****triphenyl phosphine (TPP), N-methylimidazole (NMI), and dibutyl tin dilaurate (DiBSn)
*****Silica refers to the composition described in Sample 1.
******Tg is in degrees Celsius as measured by DSC (mid-point of inflection).

### Example 4

### The Coefficient of Thermal Expansion Performance of Wafer Level Underfill (WLU)

A plurality of 10 micrometer thick films are prepared from the above-disclosed Samples are cast on Teflon slabs (with the dimensions 4 inch×4 inch×0.25 inch) and dried at 40 degrees Celsius and 100 mmHg overnight to give a transparent hard film. The film is further dried at 85 degrees Celsius and 150 mmHg. The film is cured according to the method of Example 3. The coefficient of thermal expansion (CTE) values are measured by thermal mechanical analysis (TMA). The samples are cut to 4mm width using a surgical blade and the CTE is measured using a thin film probe on the TMA.

Thermal Mechanical Analysis is performed on a TMA 2950 Thermo Mechanical Analyzer from TA Instruments. Experimental parameters are set at: 0.05 Newtons of force, 5.000 grams static weight, nitrogen purge at 100 mL/min, and 2.0 sec/pt sampling interval. The sample is equilibrated at 30 degrees Celsius for 2 minutes, followed by a temperature ramp at 5.00 degrees Celsius/min to 250.00 degrees Celsius, equilibrated for 2 minutes, ramped downward at 10.00 degrees Celsius/min to 0.00 degrees Celsius, equilibrated for 2 minutes, and ramped from 5.00 degrees Celsius/min to 250.00 degrees Celsius.

Table 3 below provides the CTE data obtained. The results for the samples 18-19 in Table 3 include films that are transparent. Transparent films are in contrast to films generated from compositions in which 5-micrometer fused silica is used. Both the 5 micron fused silica and the compatibilized and passivated silica particles are used at the same loading rate of 50 weight percent. Moreover, the reduction in CTE exhibited by these materials (Samples 18-19) over the unfilled resin. The results for Sample 17 indicate that the compatibilized and passivated silica particles may be effective in reducing resin CTE.

TABLE 3
CTE of Samples

| | CTE Below | CTE Above |
|---|---|---|
| | glass transition temperature | glass transition temperature |
| | (μm/m degrees Celsius) | (μm/m degrees Celsius) |
| Sample 17, | 70 | 210 |
| unfilled resin | | |
| Sample 18 | 46 | 123 |
| (TPP level | | |
| 0.015 grams) | | |
| Sample 19 | 40 | 108 |
| (NMI level | | |
| 0.0075 grams) | | |

### Example 5

### Solder Wetting and Reflow Experiments

The following examples demonstrate the wetting action of solder bumps in the presence of a wafer level underfill.

Part A:

Bumped flip chip dies are coated with a layer of the experimental underfill material from Sample 10. The underfill coating contained about 30 weight percent of solvent. To drive off the solvent, the coated chips are baked in a vacuum oven at 85 degrees Celsius and 150 mmHg. The tip of the solder bumps are exposed, and a transparent B-staged resin layer coats an active surface of the chip.

Part B:

Solder bump wetting is not hindered by the presence of a B-staged layer. A relatively thin coating of flux is applied to a Cu-clad FR-4 coupon (a glass epoxy sheet laminated with copper commercially available from MG Chemicals). The flux (KESTER TSF 6522 TACFLUX) is applied in the area where the solder bumps would contact the copper surface. The assembly is subjected to reflow in a Zepher convection reflow oven (MannCorp). After reflow, the dies are manually sheared off. The sheared dies are inspected for wet-out solder on the copper surface. Molten solder that had wet the copper surface remained adhered to the board, indicating that the wetting ability, in the presence of tacky flux, is not hindered by the B-staged layer of wafer level underfill material.

Part C:

Coated chips are prepared using the methodology described in Part A. These chips are assembled on to a test board, with a daisy chain test pattern. The test board used is a 62 mil thick FR-4 board commercially available from MG Chemicals. The pad finish metallurgy is Ni/Au. Tacky flux (KESTER TSF 6522) is syringe dispensed onto the exposed pads on the test board, using a 30 gauge needle tip and an EFD manual dispenser (EFD, Inc.). The dies are placed on the board with the help of an MRSI 505 automatic pick and place machine (Newport/MSRI Corp.). The assembly is subjected to reflow in a Zepher convection reflow oven. Electrical resistance readings of ˜2 ohms (measured with a Fluke multimeter) indicated that the solder had wet the pads in the presence of the wafer level underfill. X-ray analysis of the chip assembly attached to the Cu pads for both a control die and a die coated with the composition of the disclosure is conducted utilizing an X-ray machine having a MICROFOCUS X-ray tube. The results of the X-ray analysis indicated solder wetting of the Cu pads, in that the solder bumps showed similar solder ball morphology for both the control and experimental resins after reflow.

### Example 6

### Preparation of a Predispersion of Compatibilized and Passivated Silica Particles

A compatibilized and passivated silica particles predispersion, Sample 20, is prepared by combining the following: 1035 grams of isopropanol is slowly added while stirring to 675 grams of aqueous colloidal silica (SNOWTEX OL, Nissan Chemical Company) containing from weight percent 20 to 21 weight percent of 50 nanometers particles of silica. Subsequently, 17.6 grams phenyl trimethoxysilane (PTS), is added to the stirred mixture. The mixture is heated to 80 degrees Celsius for 1-2 hours to afford a pre-dispersion of compatibilized and passivated silica particles stored at room temperature.

### Example 7

### Preparation of a Dispersion of a Compatibilized and Passivated Silica Particles in Solvent

A round bottom 2000 ml flask is charged with 540 grams of each of the pre-dispersions, Sample 20. Additional pre-dispersion compositions are prepared as Samples 21-25. Continuing with Sample 20, 1-methoxy-2-propanol (750 grams) is added to each flask. The resulting dispersion of compatibilized and passivated silica particles is vacuum stripped at 60 degrees Celsius and 60 mmHg to remove about 1 L of solvents. The vacuum is slowly decreased and solvent removal continued with good agitation until the dispersion weight had reached 80 grams. The dispersion of phenyl-compatibilized and passivated silica particles contained 50 weight percent silica and no precipitated silica. The dispersion is stable at room temperature for more than three months. The results in Table 4 indicate that a certain level of phenyl functionality may prepare a concentrated, stable compatibilized and passivated silica particle dispersion in 1-methoxy-2-propanol. Sample 3 is included for comparison.

TABLE 4

| | Pre-dispersion | Final Dispersion | |
|---|---|---|---|
| | Composition | Concentration (size) | Dispersion Stability |
| Sample | (PTS/100 g silica) | (wt silica) | (in methoxypropanol) |
| 20 | 0.067 m/100 g | 47 weight percent silica 50 nm | Marginally stable |
| 21 | 0.0838 m/100 g | 50 weight percent silica 50 nm | Stable |
| 22 | 0.134 m/100 g | 50 weight percent silica 50 nm | Stable |
| 23 | 0.268 m/100 g | 50 weight percent silica 50 nm | Stable |
| 24 | 0.134 m/100 g | 47 weight percent silica 50 nm | Stable |
| 25 | 0.134 m/100 g | 50 weight percent silica 20 nm | Stable |

### Example 8

### Preparation of Curable Composition Including a Dispersion of Compatibilized and Passivated Silica Particles in a Curable Resin

A curable composition is prepared in which a resin and a hardener are added in a solvent to form a mixture. The mixture is stirred and heated at 50 degrees Celsius until a transparent suspension forms. The transparent suspension is cooled and a catalyst solution of N-methylimidazole, 60 microliters of a 50 percent w/w solution in methoxypropanol is added while stirring. The transparent solution is used directly to cast resin films for characterization or stored at negative 10 degrees Celsius. Additional films are prepared using differing catalysts in various amounts and variations in the epoxy/hardener composition and various compatibilized and passivated silica particle dispersions as set forth in Table 5 below, which shows final resin compositions.

Films are cast by spreading a portion of the epoxy-silica dispersion on glass plates, and the solvent is removed in vacuum oven at 90 degrees Celsius/200 mmHg for 1 hour and 90 degrees Celsius/100 mmHg for an additional hour. The glass plates are removed and the remaining film is a transparent and solid B-stage material. In some cases, the film is cured at 220 degrees Celsius for 5 minutes followed by heating at 160 degrees Celsius for 60 minutes. Glass transition temperature measurements are obtained by Differential Scanning Calorimetry using a commercially available DSC from Perkin Elmer. The results of DSC analysis are set forth below in Table 6. Methoxy-propanol is abbreviated MPol.

TABLE 5
Amounts in grams unless otherwise indicated.

| | Filler* (Wt | | | | | | Catalyst |
|---|---|---|---|---|---|---|---|
| Sample | % silica) | Epoxy A** | Epoxy B** | Hardener A*** | Hardener B*** | MPol | (Wt %)**** |
| 25 | 0 | ECN | — | TAMANOL | — | 3 | 0.14 |
| | | (5.3) | | (2.6) | | | |
| 26 | Denka 40 | ECN | — | TAMANOL | — | 3 | 0.14 |
| | | (5.3) | | (2.6) | | | |
| 27 | Sample 3 | ECN | — | TAMANOL | — | 3 | 0.14 |
| | (50) | (5.3) | | (2.6) | | | |
| 28 | Sample 3 | ECN | — | TAMANOL | — | 3 | 0.14 |
| | (10) | (5.3) | | (2.6) | | | |
| 29 | Sample 3 | ECN | — | TAMANOL | — | 3 | 0.14 |
| | (15) | (5.3) | | (2.6) | | | |
| 30 | Sample 20 | ECN | — | TAMANOL | — | 3 | 0.14 |
| | (20) | (5.3) | | (2.6) | | | |
| 31 | Sample 20 | ECN | — | TAMANOL | — | 3 | 0.14 |
| | (30) | (5.3) | | (2.6) | | | |
| 32 | Sample 20 | ECN | UVR6105 | HRJ (2.6) | — | 3 | 0.14 |
| | (30) | (5.0) | (0.475) | | | | |
| 33 | Sample 20 | ECN | UVR6105 | HRJ (2.6) | — | 3 | 0.14 |
| | (60) | (5.0) | (0.475) | | | | |
| 34 | Sample 20 | ECN | UVR6105 | HRJ (2.6) | — | 3 | 0.14 |
| | (50) | (4.5) | (0.945) | | | | |
| 35 | Sample 20 | ECN | UVR6105 | HRJ (2.6) | — | 3 | 0.14 |
| | (50) | (4.0) | (1.52) | | | | |
| 36 | Sample 24 | ECN | — | TAMANOL | — | 2.7 | 0.14 |
| | (10) | (4.9) | | (2.4) | | | |
| 37 | Sample 24 | ECN(4.9) | — | TAMANOL | — | 2.7 | 0.14 |
| | (20) | | | (2.4) | | | |
| 38 | Sample 24 | ECN | — | TAMANOL | — | 2.7 | 0.14 |
| | (30) | (4.9) | | (2.4) | | | |
| 39 | Sample 24 | ECN | — | TAMANOL | — | 2.7 | 0.14 |
| | (40) | (4.9) | | (2.4) | | | |
| 40 | Sample 24 | ECN | — | TAMANOL | — | 2.7 | 0.14 |
| | (50) | (4.9) | | (2.4) | | | |
| 41 | Sample 24 | ECN | DER 732 | TAMANOL | — | 1.4 | 0.14 |
| | (50) | (2.2) | (0.4) | (1.2) | | | |
| 42 | Sample 24 | ECN | DER 736 | TAMANOL | — | 1.4 | 0.14 |
| | (50) | (2.2) | (0.3) | (1.2) | | | |
| 43 | Sample 24 | ECN | — | TAMANOL | Hydroquinone | 1.6 | 0.14 |
| | (30) | (2.8) | | (1.1) | (0.5) | | |
| 44 | Sample 24 | ECN | — | TAMANOL | Hydroquinone | 1.3 | 0.14 |
| | (40) | (2.4) | | (0.9) | (0.5) | | |
| 45 | Sample 24 | ECN | — | TAMANOL | Resorcinol | 1.6 | 0.14 |
| | (30) | (2.8) | | (1.1) | (0.5) | | |
| 46 | Sample 24 | ECN | — | TAMANOL | Resorcinol | 1.3 | 0.14 |
| | (40) | (2.4) | | (0.9) | (0.5) | | |
| *Filler refers to the weight of silica in the final formulation in the form of compatibilized and passivated silica particles as described in Table 4. The filler specified as DENKA may be a 5 micron fused silica filler (FB-5LDX) available from Denka Corporation. | | | | | | | |
| **ECN refers to ESCN 195XL-25 available from Sumitomo Chemical Co. Epoxy B may be UVR6105, 3-cyclohexenyl methyl-3-cyclohexenyl carboxylate diepoxide available from Dow Chemical Co. (Midland, Michigan). DER 732 may be a polyglycol diepoxide, and DER 736 may be | | | | | | | |
| # a polyglycol diepoxide, both commercially available from Dow Chemical. | | | | | | | |

***Hardeners may be TAMANOL 758 or HRJ1583 oligomeric resins available from Arakawa Chemical Industries and Schenectady International respectively or monomeric hydroquinone or resorcinol purchased from Aldrich Chemical.
****Catalyst (N-methylimidazole) loading may be based on organic components excluding solvent.

### Example 9

### Flow Performance of Formulations

Resin films containing lead eutectic solder balls are prepared by casting a film of resin compositions described in Table 5 onto glass slides. Lead eutectic solder balls (25 mil diameter, mp 183 degrees Celsius) are placed in the film by compressing two glass slides together to insure that the balls are immersed in the resin film. These assemblies are heated in an oven at 90 degrees Celsius/200 mm for 1 hour and 90 degrees Celsius/100 mm for an additional hour to remove all solvent and convert the resin film into a hard, B-stage film with embedded solder balls. The films, when cooled to ambient temperature are generally hard as noted in Table 6. A test of the resin flow and fluxing capability is performed by placing the glass slide onto copper clad FR-4 circuit board onto which a drop of KESTER FLUX (product TSF-6522 available from the Kester division of Northrup Grumman) had been placed. The glass slide is positioned such that the solder ball/resin film is in contact with the flux. The entire assembly is placed onto a hot plate that is maintained at 230 degrees Celsius to 240 degrees Celsius. Solder balls exhibited acceptable flow and fluxing performance when the solder balls collapse and flow together. In contrast, resins with poor flow and fluxing characteristics prevented solder ball collapse and the original solder ball morphology is visually evident. Good flow and flux performance to enable solder ball melting and collapse may form good electrical connections in a device and the test described above may be a measure of utility in device fabrication.

The results summarized in Table 6 indicate that transparent films may be prepared with 50 nanometers compatibilized and passivated silica particles. On the other hand, Compositions based on conventional 5 micron filler (sample 26) may be of only marginally acceptable clarity, and may be not as transparent as compositions based on 20 nanometers compatibilized and passivated particles. However, the addition of small amounts of a cycloaliphatic epoxy monomer, UVR 6105, gives transparent films even at increased loadings of 50 nanometer compatibilized and passivated particles. Moreover, the results show that film hardness may be preserved over a range of UVR 6105 levels.

TABLE 6

| Sample # | T_{g}* | B-stage** | Clarity*** | Solder ball collapse**** |
|---|---|---|---|---|
| 25 | 190 | hard | Transparent | Complete (excellent) |
| 26 | 193 | hard | opaque | Complete (excellent) |
| 27 | 184 | hard | Transparent | No collapse, very poor |
| 28 | 185 | hard | Transparent | Complete (good) |
| 29 | — | hard | Transparent | Marginal, poor |
| 30 | — | hard | Translucent | Complete (excellent) |
| 31 | 180 | hard | Translucent | Marginal, acceptable |
| 32 | 158 | hard | Transparent | Complete (excellent) |
| 33 | 153 | hard | Transparent | Complete (excellent) |
| 34 | 160 | hard | Transparent | Complete (excellent) |
| 35 | 157 | tacky | Transparent | Complete (excellent) |
| 36 | 183 | hard | Translucent | Complete (excellent) |
| 37 | 183 | hard | Translucent | Complete (excellent) |
| 38 | 187 | hard | Translucent | Complete (excellent) |
| 39 | 190 | hard | Translucent | Marginal, acceptable |
| 40 | 203 | hard | Translucent | Marginal, poor |
| 41 | 163 | hard | Translucent | Complete (excellent) |
| 42 | 171 | hard | Translucent | Complete (excellent) |
| 43 | 183 | hard | Translucent | Complete (excellent) |
| 44 | 180 | hard | Translucent | Complete (excellent) |
| 45 | 177 | hard | Translucent | Complete (excellent) |
| 46 | 160 | hard | Translucent | Complete (excellent) |

*glass transition temperature refers to the glass transition temperature of a given material cured under standard reflow conditions as measured by DSC.
**B-stage corresponds to the state of the film after solvent removal.
***Based on a visual inspection of the film after solvent removal. Transparent may be used to designate the best clarity, Translucent may be used to designate acceptable clarity for the application (e.g., no adverse effects on wafer dicing process) and opaque may be used to designate unacceptable clarity.
****Based on visual inspection during and after heating at 200-240 degrees Celsius.

The results of Table 6 indicate that the base resin (sample 25) exhibits good flow as shown by excellent solder ball collapse; however, the resin has an unacceptably high CTE value and would be expected to give poor reliability when used as a wafer level underfill in flip-chip devices. The use of conventional 5 micrometer-sized filler (sample 26) gives lower CTE while preserving solder ball collapse, but leads to a loss of transparency, which is required for wafer dicing operations. The use of 20 nanometers filled systems gives excellent transparency but leads to a loss in flow as shown by unacceptably poor solder ball collapse at a filler loading comparable to that used with the 5 micrometer-sized filler. Good solder ball collapse may be observed at 10 weight percent silica 20 nanometers filler but not at greater than 15 weight percent silica 20 nanometers filler. Use of 50 nanometer-sized filler shows an increase in flow as shown by good solder ball collapse at amounts of up to about 30 weight percent filler. Furthermore, addition of a cycloaliphatic epoxy resin to the formulations provides both a gain in flow as well as relatively improved film transparency with a similar result being obtained with addition of aliphatic epoxy resins. Furthermore, similar improvements in flow may be also realized with combinations of 50 nanometers filler and monomeric hardeners that may include some dihydroxy compounds.

### Example 10

### Preparation of Difunctional Siloxane Anhydride

A 500 milliliter (ml) flask equipped with mechanical stirrer, thermometer, condenser, addition funnel and nitrogen inlet is charged with 127 grams (0.77 mols) of 5-norbomene-2,3-dicarboxylic anhydride, 150 grams of toluene and 20 ppm of platinum as KARSTEDT'S catalyst (i.e., a complex of Pto with divinyl tetramethyl disiloxane). The solution is heated to 80 degrees Celsius and 84.3 grams (0.4 mols) of 1,1,3,3,5,5-hexamethyltrisiloxane is added drop-wise to the reaction mixture. A mild exotherm occurs and the temperature is raised to 100 degrees Celsius. The addition of silicone hydride is completed in 1 hour. The reaction mixture is stirred at 80 degrees Celsius for an additional hour. Infrared (IR) analysis is conducted using an AVATAR 370 FT-IR (from Thermo Electron Corporation); the results showed 75 percent conversion of Si-H groups. An additional 20 ppm of the platinum catalyst is added and the reaction mixture is heated to 80 degrees Celsius with stirring under nitrogen over night. The next morning, IR analysis is again conducted; the results showed more than 99 percent consumption of Si-H. The reaction mixture is cooled to room temperature.

The cooled reaction mixture is mixed with 300 ml of hexane. A precipitation of white powder is observed. The solid material is separated by filtration and dried in vacuum oven at 50 degrees Celsius to afford 180 grams of the desired difunctional siloxane anhydride (e.g., Sample 47). ¹H, ²⁹Si NMR is conducted using a 400 MHz BRUKER AVANCE 400 to confirm both the structure and purity of the anhydride. The BRUKER AVANCE 400 may be commercially obtained from the Bruker BioSpin Corporation (Billerica, Mass.).

### Example 11

### Preparation of Compatibilized and Passivated Silica Particles Pre-Dispersion

A compatibilized and passivated silica particles pre-dispersion (e.g., Sample 48) is prepared using the following procedure. 465 grams of aqueous colloidal silica (NALCO 1034A, Nalco Chemical Company) containing about 34 weight percent of 20 nanometers particles of silica, is mixed with 800 grams of isopropanol and 56.5 grams of phenyl trimethoxy silane while stirring. The mixture is heated to 60 to 70 degrees Celsius for 2 hours to give a transparent suspension. The resulting pre-dispersion is cooled to room temperature and stored in a glass bottle.

### Example 12

### Preparation of Resin Containing Stabilized Compatibilized and Passivated Silica Particles

A 1000-milliliter (ml) flask is charged with 300 grams of the colloidal silica pre-dispersion Sample 48, 150 grams of 1-methoxy-2-propanol as solvent and 0.5 grams of crosslinked polyvinylpyridine. The mixture is stirred at 70 degrees Celsius. After 1 hour the suspension is blended with 4 grams CELITE® 545 (a commercially available diatomaceous earth filtering aid), cooled down to room temperature and filtered. The resulting dispersion of compatibilized and passivated silica particles is blended with 30 grams of 3,4-epoxy cyclohexyl methyl-3,4-epoxy cyclohexane carboxylate (UVR6105 from Dow Chemical Company) and 10 grams of bisphenol-F epoxy resins (RSL-1739) and vacuum stripped at 75 degrees Celsius at 1 Torr to a constant weight to yield 88.7 grams of a viscous liquid resin—Sample 49.

### Example 13

### Preparation of Epoxy Fluxing Composition

5 grams of the compatibilized and passivated silica particles resin of Sample 49 is blended at room temperature with 1.56 grams of 4-methyl-hexahydrophthalic anhydride (MHHPA) (from Aldrich) and 1.56 grams of 5,5′-(1,1,3,3,5,5-hexamethyl-1,5-trisiloxanediyl)bis(hexahydro-4,7-methanoisobenzofuran-1,3-dione) (TriSDA) (e.g., Sample 48). 0.01 grams of catalyst (POLYCAT SA-1 from Air Products) and 0.07 grams of γ-glycidoxy propyltrimethoxy silane (GE Silicones) are added at room temperature. The formulations are blended at room temperature for approximately 10 minutes. The formulation is degassed at high vacuum at room temperature for 20 minutes. The resulting material, Sample 50, is stored at negative 40 degrees Celsius.

### Example 14

### Chip Coating Procedure

Silicon die and quartz die are coated with the wafer level underfill material described above in Table 2, sample 9 of Example 3. The silicon die is a perimeter array PB08 with 8 mil pitch, nitride passivation, diced from a wafer purchased from DELPHI DELCO ELECTRONICS. The quartz die is a perimeter array, 8 mil pitch, diced from a wafer purchased from PRACTICAL COMPONENTS. The underfill material is printed onto individual die using a mask fixture such that the tops of the solder balls are covered. A B-stage process is carried out by placing the coated die in a vacuum oven so that the die are subjected to a surface temperature of 95 degrees Celsius and vacuum of 200 mmHg for one hour, followed by an additional one hour at 100 mmHg. The die are removed from the oven and allowed to cool to room temperature.

A copper clad FR4 board (commercially available from MG Chemicals) is cleaned by sanding with 180 grit paper followed by thorough cleaning with isopropanol and a lint free cloth. Two different fluxing resins are examined. In each case a center dot dispense of fluxing agent is applied to the clean board using an EFD 1000 series dispenser followed by placement of the quartz coated die. The test assembly is passed through a Zepher convection reflow oven using a reflow profile: the maximum temperature rising slope is 2.1 degrees Celsius/second; the time between 130 degrees Celsius and 160 degrees Celsius is 53 seconds; the temperature rising time above 160 degrees Celsius is 120 seconds; the time between 160 degrees Celsius and 183 degrees Celsius is 74 seconds; and the time above 183 degrees Celsius is 70 seconds, with a maximum temperature of 216 degrees Celsius followed by a temperature decrease of 2.5 degrees Celsius per second.

Three chip/board assemblies are prepared. For the first assembly, a tacky flux (KESTER TSF 6522 TACFLUX) is dispensed on the FR4 copper clad board and utilized as the fluxing agent. A quartz die coated with the wafer level underfill composition described above in Sample 16 is applied to the fluxing resin and subjected to reflow. Examination of the assembly after reflow showed extensive, unacceptable voiding although good solder wetting is noted.

For the second assembly, the fluxing resin of Sample 50 above is dispensed on the FR4 copper clad board. A quartz die coated with the wafer level underfill composition described above in Sample 16 is applied to the fluxing resin and subjected to reflow. Examination after reflow of the assembly showed no voiding and evidence of excellent adhesion.

For the third assembly, the fluxing resin of Sample 50 above is dispensed on the FR4 copper clad board. A silicon die coated with the wafer level underfill composition described above in Sample 16 is applied to the fluxing resin and the assembly subjected to reflow. Examination after reflow of the assembly shows excellent adhesion. Removal of the die shows no voiding present. The example demonstrates the benefit of using solvent-modified epoxy resin in producing B-stage resin films, in combination with a second fluxing resin to produce void-free, high adhesion, conductive chip assemblies.

### Example 15

### Active Termination Site Density Versus Stability

Samples are prepared as follows. A slurry of compatibilized and passivated silica particles nano-particles having a solids weight percentage of 32.9 is added to a passivating agent as shown in Table 7, and by methods as disclosed above. The passivating agent is hexamethyl disilazane (HMDZ), and the filler and passivating agent are mixed, reacted, and cooled. Solids content is measured for each of the samples, and the results are listed in Table 7. To each of the samples are added 7.5 grams of a first curable resin (3-cyclohexenyl methyl-3-cyclohexenyl carboxylate diepoxide (UVR6105)); 2.5 grams of a second curable resin (bisphenol-F epoxy resin (RSL-1739)); and a solvent (SR83-068). The samples are mixed and vacuum stripped at high vacuum.

TABLE 7
Samples 51-58 preparation of filler in curable resin systems with differing
amounts of passivating agent.

| | Sample | Sample | Sample | Sample | Sample | Sample | Sample | Sample |
|---|---|---|---|---|---|---|---|---|
| Formulation | 51 | 52 | 53 | 54 | 55 | 56 | 57 | 58 |
| Filler | 50 | 50 | 50 | 50 | 50 | 50 | 50 | 50 |
| Passivating agent | 0.1 | 0.25 | 0.5 | 1 | 1.5 | 1.75 | 2 | 3 |
| HMDZ mmols/g | 0.0378 | 0.0944 | 0.1888 | 0.3776 | 0.5664 | 0.6608 | 0.7552 | 1.1327 |
| silica | | | | | | | | |
| Solids content | 0.34 | 0.332 | 0.334 | 0.3317 | 0.33 | 0.333 | 0.329 | 0.3202 |
| Curable resin A | 7.5 | 7.5 | 7.5 | 7.5 | 7.5 | 7.5 | 7.5 | 7.5 |
| Curable resin B | 2.5 | 2.5 | 2.5 | 2.5 | 2.5 | 2.5 | 2.5 | 2.5 |
| SR83-068 | 24.1 | 24.7 | 24.6 | 24.7 | 24.8 | 24.6 | 24.9 | 25.6 |
| m = | 18.06 | 18.2 | 18.37 | 18.7 | 18.11 | 18.07 | 18.93 | 18.67 |

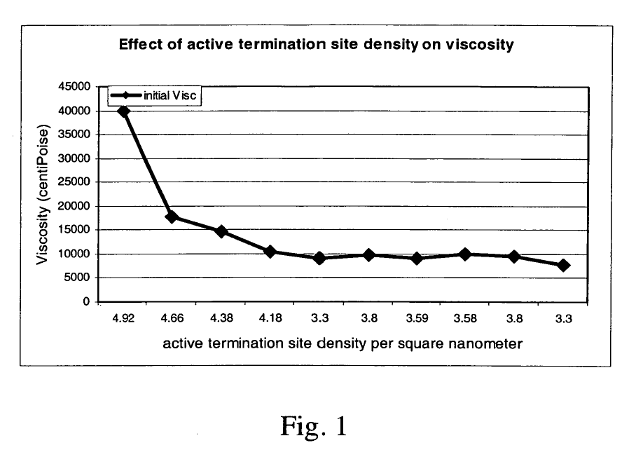

Samples 51-58 are each measured for initial viscosity using a Brookfield-type viscometer. Spindle 1, 153 1/second, all viscosity results are in centipoise unless otherwise stated, and are listed in Table 8. Additionally, data is plotted in the Graph shown in FIG. 1 showing that increasing amounts of passivating agent reduce initial viscosity. It may be that decreased numbers of hydrogen bonds facilitates movement of particles in a filled system.

TABLE 8
Initial viscosity measurements.

| | | | | Sam- | Sam- | Sam- | Sam- | |
|---|---|---|---|---|---|---|---|---|
| | Sample | Sample | Sample | ple | ple | ple | ple | Sample |
| | 51 | 52 | 53 | 54 | 55 | 56 | 57 | 58 |
| Initial | 17756 | 14700 | 10440 | 9040 | 9000 | 9937 | 9620 | 7669 |
| Visc. | | | | | | | | |

FIG. 1 illustrates a relationship between active termination site density and initial viscosity. For silica, the viscosity curve apex is about 4.5. That is, fewer than about 4.5 active termination sites per square nanometer result in a resin system with a relatively lower initial viscosity.

The samples are measured for subsequent viscosity in a similar manner as the initial viscosity, but one week later than the initial viscosity and one week of aging at 60 degrees Celsius. The results are shown in Table 9.

TABLE 9
Viscosity measurements (cPs) after one week of aging at 60 degrees Celsius.

| Viscosity | Sample | Sample | Sample | Sample | Sample | Sample | Sample | Sample |
|---|---|---|---|---|---|---|---|---|
| measurement | 51 | 52 | 53 | 54 | 55 | 56 | 57 | 58 |
| Spindle 1, 153/s | — | — | 15190 | 10090 | 9750 | 11006 | 10519 | 8756 |
| Spindle 6, 33/s | 60700 | — | — | — | — | — | — | — |
| Spindle 6, 50/s | 161000 | — | — | — | — | — | — | — |
| Spindle 6, 67/s | 361500 | 37900 | — | — | — | — | — | — |
| Spindle 6, 153/s | — | 124100 | — | — | 12200 | — | — | — |
| Spindle 6, 333/s | — | — | — | — | 18200 | — | — | — |

The samples are measured for subsequent viscosity in a similar manner as the initial viscosity, but one week later than the initial viscosity and two weeks of aging at 60 degrees Celsius. The results are shown in Table 10.

TABLE 10
Viscosity measurements (cPs) after two weeks of aging at 60 degrees Celsius.

| Viscosity | Sample | Sample | Sample | Sample | Sample | Sample | Sample | Sample |
|---|---|---|---|---|---|---|---|---|
| measurement | 51 | 52 | 53 | 54 | 55 | 56 | 57 | 58 |
| Spindle 6, 331/s | >1,000,000 | 225700 | 23300 | 16500 | 15000 | 15000 | 15500 | 15500 |
| Spindle 6, 671/s | — | 303000 | 27400 | 16100 | 15500 | 15500 | 12800 | 11600 |

The samples are initially measured for active termination sites or Bronsted sites using Nuclear Magnetic Resonance Imaging (NMR). Also, the surface area of the filler material is determined using corrected BET-C. Results are shown in Table 11.

TABLE 11
and surface area data for samples 15A-15H.

| | Sample | Sample | Sample | Sample | Sample | Sample | Sample | Sample |
|---|---|---|---|---|---|---|---|---|
| Si NMR data | 51 | 52 | 53 | 54 | 55 | 56 | 57 | 58 |
| M | 0.2% | 0.6% | 1.7% | 3.7% | 4.8% | 4.8% | 5.8% | 7.3% |
| TOH | 2.2% | 2.4% | 2.2% | 2.1% | 1.9% | 1.9% | 1.8% | 1.7% |
| T | 2.0% | 2.1% | 2.5% | 2.8% | 2.5% | 2.4% | 2.7% | 3.0% |
| QOH | 54.4% | 52.6% | 48.6% | 45.8% | 45.0% | 45.6% | 43.2% | 41.4% |
| Q | 41.2% | 42.3% | 45.1% | 45.6% | 46.0% | 45.3% | 46.4% | 46.5% |
| BET-C Data | — | — | — | — | — | — | — | — |
| Surface Area | 167.10 | 163.90 | 161.10 | 145.00 | 150.90 | 151.00 | 148.90 | 143.60 |
| (Corrected) | | | | | | | | |
| BET-C value | 57.53 | 52.35 | 48.68 | 32.50 | 37.95 | 37.72 | 34.70 | 32.63 |
| SiOH/nm\hat{ }2 | 4.66 | 4.38 | 4.18 | 3.30 | 3.59 | 3.58 | 3.41 | 3.30 |

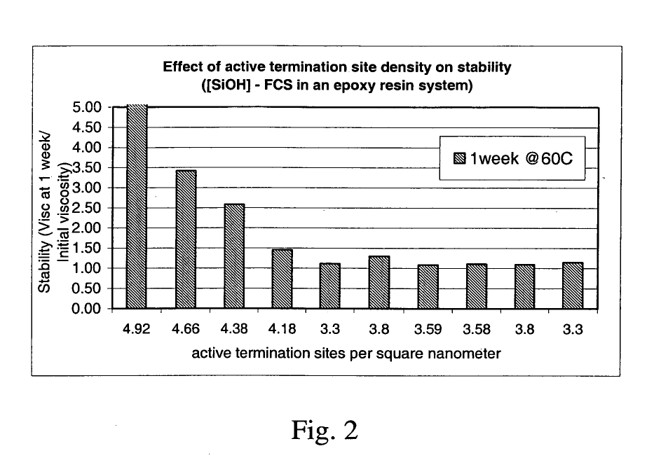

FIG. 2 is a graph that illustrates the relationship of density of active termination sites to stability. That is, a function of viscosity increase over time as related to the number of silanol groups per square nanometer of surface area, in the instance. Of note is that there are a measurable number of active termination sites, and that number is controllable. By controlling the number of active termination sites, the formulation instability, or viscosity rise attributable to premature cross-linking of the curable monomer, is controllable.

The following section provides experimental details on the preparation of the compatibilized colloidal silica samples as well as properties of epoxy formulations that incorporate these materials. The data in the following tables substantiate the assertion that an advantageous combination of reduction of Coefficient of Thermal Expansion (“CTE”) and preservation of material transparency can be obtained with the use of the appropriate compatibilized colloidal silica. Resins with appropriate compatibilized colloidal silica also permit formulation of molding compounds with acceptable spiral flow and low CTE.

The data indicates that improvements in the stability of initial formulation viscosity may be obtained. Film transparency, CTE reduction and spiral flow length is relatively improved.

### Example 16

### Preparation of Compatibilized Colloidal Silica Pre-Dispersion

The following general procedure is used to prepare compatibilized colloidal silica pre-dispersions with the proportions of reagents given in Table 12. For example, a mixture of aqueous colloidal silica (465 (grams); 34 weight percent silica, Nalco 1034a), isopropanol (800 grams) and phenyltrimethoxy silane (56.5 grams) is heated and stirred at 60 degrees Celsius to 70 degrees Celsius for 2 hours to give a transparant suspension.

TABLE 12
Compatibilized Colloidal Silica Pre-dispersions

| | Isopropanol | Nalco 1034 | Additive |
|---|---|---|---|
| Sample | (grams) | (grams) | (grams) |
| 59 | 546 | 403 | MAPPS* (60.4) |
| 60 | 800 | 465 | PHTS** (56.5) |
| 61 | 314 | 230 | GPTMS*** (33.0) |
| 62 | 500 | 325 | ECETS**** (53) |

MAPPS is 3-(methacryloxy)propyltrimethoxysilane
**PHTS is phenyltrimethoxysilane
***GPTMS is 3-(glycidoxypropyl)trimethoxysilane
****ECETS is beta-(3,4-epoxycyclohexyl)ethyltrimethoxysilane

The resulting mixture is stored at room temperature.

### Example 17

### Preparation of Compatibilized Colloidal Silica Dispersions

The pre-dispersion (Example 16) is blended with UVR6105 epoxy resin and UVR6000 oxetane resin from Dow Chemical Company and 1-methoxy-2-propanol. The mixture is vacuum stripped at 75 degrees Celsius at 1 mmHg to the constant weight to yield a viscous or thixotropic fluid.

TABLE 13

| | Sample | Sample | Sample | Sample | Sample | Sample |
|---|---|---|---|---|---|---|
| | 63 | 64 | 65 | 66 | 67 | 68 |
| Reagents/g | | | | | | |
| Sample 60 | 30 | 30 | 30 | 30 | 30 | 30 |
| 1-Methoxy-2- | 30 | 30 | 30 | 30 | 30 | 30 |
| propanol | | | | | | |
| UVR6105 | 21 | 14 | 12 | 3 | 1.5 | |
| UVR6000 | | 7 | 12 | 3 | 4.5 | 6 |
| Properties | | | | | | |
| Yield/g | 27 | 26.8 | 30.4 | 11 | 11 | 11.2 |
| % of particle | 22 | 22 | 21 | 45.5 | 45.4 | 47.2 |
| by weight | | | | | | |
| Viscosity | TF | TF | ND | TF | TF | ND |
| at 25° C./cPs | | | | | | |
| Viscosity at | 2920* | 1450* | 410* | 5960* | 346* | 189* |
| 60° C./cPs | | | | | | |

TF - Thixotropic fluid
*spindle # 52, 50 RPM

TABLE 14

| | Sample | Sample | Sample | Sample | Sample |
|---|---|---|---|---|---|
| | 69 | 70 | 71 | 72 | 73 |
| Reagents/g | | | | | |
| Sample 60 | — | — | 3 | 10 | 15 |
| Sample 62 | 30 | 30 | 27 | 20 | 15 |
| 1-Methoxy-2-propanol | 30 | 30 | 30 | 30 | 30 |
| UVR6105 | 6.4 | 3 | 6.4 | 6 | 6 |
| UVR6000 | — | 3 | — | — | — |
| Properties | | | | | |
| Yield/g | 11.7 | 11.4 | 11.7 | 12 | ND |
| % of particle by weight | 45.2 | 47.3 | 45.4 | 50 | 21 |
| Viscosity at 25° C./cPs | TF | ND | TF | TF | GEL |
| Viscosity at 60° C./cPs | 600 | 157 | 928 | 2360 | ND |

TF - Thixotropic fluid
*spindle # 52, 50 RPM

### Example 18

### Preparation of Stabilized Compatibilized Colloidal Silica Dispersions

A 250 milliliter (ml) flask is charged with 50 grams of pre-dispersions (Example 1.1), 50 grams of 1-methoxy-2-propanol and 0.5 grams of basic resins (Table 15). The mixture is stirred at 70 degrees Celsius. After 1 hour the suspension is blended with 50 grams of 1-methoxy-2-propanol and 2 grams CELITE® 545, cooled down to room temperature and filtered. The resulting dispersion of compatibilized colloidal silica is blended with 12 grams of UVR6105 Dow Chemical Company and vacuum stripped at 75 degrees Celsius at 1 mmHg to the constant weight to yield a viscous resin (Samples 74-78). Viscosity of the resin is measured at 25 degrees Celsius immediately after synthesis and again after 6 weeks.

### Example 19

### Preparation of Stabilized Compatibilized Colloidal Silica Dispersions

A 250 ml flask is charged with 50 grams of pre-dispersions (Example 1.1), 50 grams of 1-methoxy-2-propanol and 5 grams of basic alumina (Table 15, Entry 16). The mixture is stirred at room temperature for 5 min. The suspension is blended with 50 grams of 1-methoxy-2-propanol and 2 grams CELITE® 545 and filtered. The resulting dispersion of compatibilized colloidal silica is blended with 12 grams of UVR6105 Dow Chemical Company and vacuum stripped at 75 degrees Celsius at 1 mmHg to the constant weight to yield a viscous resin (Sample 78). Viscosities of the resins are measured at 25 degrees Celsius immediately after synthesis and again after 3 weeks.

TABLE 15

| | Sample | Sample | Sample | Sample | Sample |
|---|---|---|---|---|---|
| | 74 | 75 | 76 | 77 | 78 |
| Reagents/g | | | | | |
| Sample 60 | 50 | 50 | 50 | 50 | 50 |
| 1-Methoxy-2-propanol | 50 | 50 | 50 | 50 | 50 |
| Basic Resin | none | PVP 2% | PVP 25% | PSDVBA | Alumina |
| Amount of resin/g | | 0.5 | 0.5 | 1 | 5 |
| UVR6105 | 12 | 12 | 12 | 12 | 12 |
| Properties | | | | | |
| Yield/g | 25 | 20 | 19.5 | 18.5 | 18 |
| % of Functional CS | ND | 40 | 38.5 | 35.1 | 33.3 |
| Initial viscosity at 25° C./cPs | Solid | 4820** | 1943** | 2480** | 1620** |
| Viscosity after 6 weeks at | Solid | 237000 | 19300 | 13650 | Solid*** |
| 25 C/cPs | | | | | |

PVP 2% - Polyvinylpyridine - 2% crosslinked - Aldrich
PVP 25% - Polyvinylpyridine - 25% crosslinked - Aldrich
PSDVBA - Poly(styrene-co-divinylbenzene) amine compatibilized - Aldrich
Basic Alumina - Aldrich
*spindle # 40, 5 RPM
**spindle #52, 20 RPM
***spindle # 40, 5 RPM, 3 weeks data

### Example 20

### Preparation of Stabilized and Compatibilized Particle Dispersions

A 250 ml flask is charged with 50 grams of pre-dispersions, and the desired amount of ammonia (Table 16, Entry 17, 19, 20, 21) or triethylamine (Table 16, Entry 18). The mixture is stirred at room temperature for 5 min. Next, the mixture is blended with 50 grams of 1-methoxy-2-propanol and 12 grams of UVR6105 Dow Chemical Company and vacuum stripped at 75 degrees Celsius at 1 mmHg to the constant weight to yield a viscous resin. Viscosity of the resin is measured at 25 degrees Celsius immediately after synthesis and in 3 weeks.

TABLE 16
Weights are in (grams).

| | Sample | Sample | Sample | Sample | Sample |
|---|---|---|---|---|---|
| | 79 | 80 | 81 | 82 | 83 |
| Reagents/g | | | | | |
| Pre-dispersion | Sample 60 | Sample | Sample 59 | Sample 60 | Sample 61 |
| | (50) | 60 (50) | (230) | (360) | (72) |
| 1-Methoxy-2-propanol | 50 | 50 | 150 | 200 | 200 |
| Reagent | Ammonia | TEA | Ammonia | Ammonia | Ammonia |
| Amount of resin/g | 0.25 | 2 | 1.2 | 1.6 | 1.6 |
| UVR6105 | 12 | 12 | 40 | 43 | 43 |
| Properties | | | | | |
| Yield/g | 19.5 | 20.8 | 84.6 | 98.5 | 95 |
| % of particles by weight | 38.5 | 42.3 | 52.7 | 56.3 | 54.7 |
| Initial viscosity at 25° C./cPs | 4600* | 2540* | — | — | — |
| Viscosity after 6 weeks at | 37400*** | 3820*** | — | — | — |
| 25 C./cPs | | | | | |

Ammonia - 5 wt % solution of ammonia in water
TEA - 5 wt % solution of triethylamine in isopropanol
*spindle # 40, 5 RPM
***spindle # 40, 5 RPM, 3 weeks data

### Example 21

### Effect of Concentration of Stabilized Blend of Phenylsilane-Compatibilized Particles with Epoxy Resin on Viscosity

A 250 ml flask is charged with 50 grams of pre-dispersion (Sample 60), 50 grams of 1-methoxy-2-propanol, and 0.5 grams of PVP at 25 percent. The mixture is stirred at 70 degrees Celsius. After 1 hour the suspension is blended with 50 grams of 1-methoxy-2-propanol and 2 grams of CELITE® 545. The blend is cooled down to room temperature and filtered. The resulting dispersion of compatibilized colloidal silica is blended with the desired amount of UVR6105 Dow Chemical Company and vacuum stripped at 75 degrees Celsius at 1 mmHg to constant weight to yield a viscous resin. Additional Samples are prepared with differing amounts of the UVR6105 as shown in Table 17. Viscosity of each resin is measured at 25 degrees Celsius immediately after synthesis and again after 6 weeks.

TABLE 17

| | Sample | Sample | Sample | Sample | Sample |
|---|---|---|---|---|---|
| | 84 | 85 | 86 | 87 | 88 |
| Reagents/g | | | | | |
| Sample 60 | 50 | 50 | 50 | 50 | 50 |
| 1-Methoxy-2-propanol | 50 | 50 | 50 | 50 | 50 |
| PVP 25% | 0.5 | 0.5 | 0.5 | 0.5 | 0.5 |
| UVR6105 | 12 | 10 | 8 | 6 | 4 |
| Properties | | | | | |
| Yield/g | 19.54 | 17.62 | 16.6 | 14.4 | 12.7 |
| % of CS | 38.5 | 43.2 | 51.8 | 58.3 | 68.5 |
| Initial viscosity at 25° C./cPs | 1943* | 2240* | 2470* | 7500* | 38800** |
| Initial viscosity at 60° C./cPs | 197*** | 210*** | 480*** | 1200* | 5500* |
| Viscosity after 6 weeks at 25° C./cPs | 19300** | 116500** | Solid | Solid | Solid |

PVP 25% - Polyvinylpyridine - 25% crosslinked - Aldrich
*spindle # 52, 20 RPM
**spindle # 52, 10 RPM
***spindle # 40, 20 RPM

The data in Tables 15, 16, and 17 demonstrates gains and/or increases in resin stability. Lower initial viscosity, and more stable long-term viscosity, being observable in materials produced according to embodiments of the invention, relative to other materials, in which the resin may solidify upon solvent removal.

### Example 22

### Compatibilized and Passivated Particles

Compatibilized particle dispersions are passivated with a passivating material, e.g., hexamethyldisilazane (“HMDZ”), using differing procedures according to embodiments.

Procedure (a) involves re-dissolution of a colloidal silica dispersion in a solvent, followed by addition of HMDZ and subsequent evaporation of solvent to give passivated and compatibilized colloidal silica particles. For example, Sample 81 (10.0 g, 50% SiO₂) is re-suspended in diglyme (10 ml) to give a transparent solution. HMDZ is added (0.5 grams or 2.0 grams) with vigorous stirring and the solution left overnight. The solutions smell of ammonia. The next day, the solutions are evaporated at 40 degrees Celsius and 1 mmHg to mobile oil. Nuclear Magnetic Resonance (“NMR”) analysis shows increased capping for the reaction with 2 grams of HMDZ as evidenced by a higher ratio of trimethylsilyl groups to colloidal silica functionality (equimolar levels).

Procedure (b) involved capping or passivating during the evaporation of the solvent. For example, the solution from Sample 81 is partially concentrated to remove 180 grams (amount equal to the methoxypropanol added), after the aliphatic epoxide addition. HMDZ (9.3 grams, ca 5% of amount of SiO₂) is added with vigorous stirring and the solution is left overnight. The solutions smell of ammonia. The next day, the solutions are evaporated at 40 degrees Celsius and 1 Torr to mobile oil. NMR analysis shows somewhat lower capping as evidenced by a 0.5:1 molar ratio of trimethylsilyl groups to colloidal silica functionality (Table 18).

TABLE 18

| | | Capping | Percent | |
|---|---|---|---|---|
| Sample | Dispersion used | procedure | capping* | Yield (grams) |
| 89 | Sample 81 | B | 50 | 86.0 |
| 90 | Sample 82 | B | 45 | 98.5 |
| 91 | Sample 83 | B | 60 | 95.0 |

Based on the maximum value of 1:1 observed for trimethylsilyl to silane compatibilization agent. For example, 50% capping means a ratio 0.5:1 for passivating trimethylsilyl to silane compatibilization agent.

The data in Table 18 demonstrates that capping or passivating of the particle surface can be achieved by procedure B.

### Example 23

### Passivating of Compatibilized Particles

A round bottom flask is charged with a pre-dispersion sample, and with 1-methoxy-2-propanol. Fifty weight percent of the total mixture is distilled off at 60 degrees Celsius and 50 mmHg. The desired amount of hexamethyldisilazane is added drop-wise to the concentrated dispersion of compatibilized colloidal silica. The mixture is stirred at 70 degrees Celsius for 1 hour. After 1 hour, CELITE® 545 is added to the flask, the mixture is cooled down to room temperature and filtered. The transparent dispersion of compatibilized colloidal silica is blended with UVR6105 Dow Chemical Company and vacuum stripped at 75 degrees Celsius at 1 mmHg to the constant weight to yield a viscous resin (Table 19). The procedure is repeated with differing amounts of materials as shown in Table 19. Viscosity of each resin is measured at 25 degrees Celsius immediately after synthesis and after 2 weeks of storage at 40 degrees Celsius.

TABLE 19

| | Sample | Sample | Sample | Sample | Sample | Sample | Sample |
|---|---|---|---|---|---|---|---|
| | 92 | 93 | 94 | 95 | 96 | 97 | 98 |
| Reagents/g | | | | | | | |
| Sample 60 | 100 | 200 | 50 | 50 | 200 | 50 | 200 |
| 1-Methoxy-2- | 100 | 200 | 50 | 50 | 200 | 50 | 200 |
| propanol | | | | | | | |
| HMDZ | 5 | 10 | 5 | 2.5 | 10 | 2.5 | 10 |
| Celite 545 | 5 | 10 | 2 | 2 | 10 | 2 | 10 |
| UVR6105 | 40 | 50 | 10 | 10 | 32 | 6 | 20 |
| Properties | | | | | | | |
| Yield/g | 56.8 | 85.6 | 17.8 | 18.6 | 64.9 | 15.6 | 53.6 |
| % particles by wt | 29.6 | 41.6 | 44 | 46.2 | 50 | 61 | 63 |
| Initial viscosity | 659** | 1260** | 1595** | 1655** | 4290** | 15900*** | 30100*** |
| at 25° C./cPs | | | | | | | |
| Initial viscosity | — | — | — | — | — | 1340** | 7050*** |
| at 60° C./cPs | | | | | | | |
| Viscosity 25° C./cPs* | — | — | 1460** | 1665** | — | — | — |

HMDZ - hexamethyldisilazane - Aldrich
*after two weeks storage at 40 C.
**spindle #52, 10 RPM
***spindle # 52, 1 RPM

### Example 24

### Capping of Compatibilized Particles with Silylating Agent

A round bottom flask is charged with a pre-dispersion and 1-methoxy-2-propanol. Next, 50 weight percent of the total mixture is distilled off at 60 degrees Celsius at 50 Torr. An amount of hexamethyldisilazane is added drop-wise to the concentrated dispersion of compatibilized colloidal silica. The mixture is stirred at 70 degrees Celsius for 1 hour. After 1 hour, CELITE® 545 is added to the flask, the mixture is cool down to room temperature and filtered. The transparent dispersion of compatibilized colloidal silica is blended with UVR6105 Dow Chemical Company and vacuum stripped at 75 degrees Celsius at 1 mmHg to the constant weight to yield a viscous resin (Table 20). Viscosity of the resin is measured at 25 degrees Celsius immediately after synthesis and after 2 weeks of storage at 40 degrees Celsius.

TABLE 20

| | Sample 92 | Sample 99 | Sample 100 |
|---|---|---|---|
| Reagents/g | | | |
| Sample 62 | — | 20 | 50 |
| Sample 60 | 100 | 80 | 50 |
| 1-Methoxy-2-propanol | 100 | 100 | 50 |
| HMDZ | 5 | 5 | 5 |
| Celite 545 | 5 | 5 | 5 |
| UVR6105 | 40 | 40 | 40 |
| Properties | | | |
| Yield/g | 56.8 | 57.3 | 57.07 |
| % of Functional CS | 29.6 | 30.1 | 29.9 |
| Initial viscosity at 25° C./cPs | 659* | 940* | 22400** |
| Initial viscosity at 60° C./cPs | — | — | 710* |

HMDZ—hexamethyldisilazane
*spindle #52, 10 RPM
**spindle #52, 1 RPM

### Example 25

### Preparation of Total Curable Epoxy Formulations

Epoxy test formulations are prepared by two different methods. Materials using conventional fused silica are prepared by adding UVR6105 (2.52 grams) to 4-methylhexahydrophthalic anhydride (2.2 grams) followed by bisphenol A (0.45 grams). The suspension is heated to dissolve the BPA and aluminum acetylacetonate (0.1 grams) is added followed by reheating to dissolve the catalyst. Fused silica (2.3 g, Denka FS-5LDX) is added and the suspension stirred to disperse the filler. The resultant dispersion is cured at 150-170 degrees Celsius for 3 hours.

Epoxy test formulations using compatibilized and passivated particulate (Table 21) are prepared by adding aluminum acetylacetonate or triphenylphosphine (0.1 grams) to methylhexahydrophthalic anhydride (2.2 g, MHHPA) and the suspension heated to dissolve the catalyst. The compatibilized and passivated particulate is added and the mixture warmed to suspend the particulate. Samples are cured at 150-170 degrees Celsius for 3 hours. Properties of the cured specimens are shown in Table 22.

TABLE 21
amounts are in grams

| | | | Catalyst Type/ | | |
|---|---|---|---|---|---|
| Sample | Resin* | MHHPA | amount | Silica | Comments |
| 101 | UVR6105 | 2.2 | Al(acac) | 2.3 | Viscosity stable overnight, |
| | (2.52) | | 0.1 | | forms opaque film on cure |
| 102 | UVR6105 | 2.2 | TPP | 2.3 | Viscosity stable overnight, |
| | (2.52) | | 0.1 | | forms opaque film on cure |
| 103 | Sample 82 | 2.2 | Al(acac) | — | Resin spontaneously cures |
| | (5.6) | | 0.1 | | |
| 104 | Sample 82 | 2.2 | TPP | — | Resin slowly cures overnight |
| | (5.60) | | 0.1 | | |
| 105 | Sample 89 | 2.2 | Al(acac) | — | Viscosity stable overnight, |
| | (5.41) | | 0.1 | | forms transparent film on cure |
| 106 | Sample 90 | 2.2 | Al(acac) | — | Viscosity stable overnight, |
| | (5.77) | | 0.1 | | forms transparent film on cure |
| 107 | Sample 91 | 2.2 | Al(acac) | — | Viscosity stable overnight, |
| | (5.55) | | 0.1 | | forms transparent film on cure |

*Amount of resin calculated to provide 2.52 g UVR6105.
TPP is triphenylphosphine,
Al(acac) is aluminum acetylacetonate.

The results of Table 21 indicate that gains in final epoxy formulation stability may be realized by capping or passivating compatibilized particles, such as colloidal silica.

TABLE 22
Results from testing of above-disclosed Samples

| Sample | T_{g} | CTE below T_{g}* |
|---|---|---|
| 101 | 180 | 50 |
| 102 | 165 | 50 |
| 103 | 155 | 50 |
| 104 | 145 | 55 |
| 105 | 143 | 50 |
| 106 | 157 | 54 |

*PPM/° C. Base resin for entry 1 showed a CTE of 70-75 ppm/degrees Celsius.

### Example 26

### Preparation of Total Curable Epoxy Formulation

Compatibilized and passivated particles including colloidal silica admixed with an epoxy resin is a blend. The blend is mixed with UV9392C ((4-Octloxypheny)phenyliodonium hexafluoro antimonate) and benzopinacole in Speed Mixer DAC400FV. A suitable mixer is available from Hauschild Company. Samples are with differing amounts of ingredients to form a number of resins. The resulting liquid to semi-solid resins are stored below 5 degrees Celsius. Some of the resulting resins are cured at 130 degrees Celsius for 20 min and post-cured at 175 degrees Celsius for 2 hours.

TABLE 23

| | Sample | Sample | Sample | Sample | Sample | Sample | Sample |
|---|---|---|---|---|---|---|---|
| | 108 | 109 | 110 | 111 | 112 | 113 | 114 |
| Composition/pph | | | | | | | |
| Sample used as resin | — | — | Sample | Sample | Sample | Sample | Sample |
| | | | 81 | 82 | 83 | 84 | 85 |
| FB-5LDX | 59.6 | 0 | 0 | 0 | 0 | 0 | 0 |
| UVR6105 | 39.8 | 98.5 | 0 | 0 | 0 | 0 | 0 |
| Resin amount | 0 | 0 | 98.5 | 98.5 | 98.5 | 98.5 | 98.5 |
| UV9392C | 0.4 | 1 | 1 | 1 | 1 | 1 | 1 |
| Benzopinacol | 0.2 | 0.5 | 0.5 | 0.5 | 0.5 | 0.5 | 0.5 |
| Carbon Black | 0 | 0 | 0 | 0 | 0 | 0 | 0 |
| Candelilla Wax | 0 | 0 | 0 | 0 | 0 | 0 | 0 |
| Properties | | | | | | | |
| Spiral Flow | ND | ND | ND | ND | ND | ND | ND |
| CTE (ppm/° C.) | 36.8 | 70 | 46 | 41.6 | 41 | 38.4 | 36.7 |
| Appearance | NT | T | T | T | T | T | T |

FB-5LDX - fused silica - Denka Corporation
UVR6105 - cycloaliphatic epoxy resin - Dow Chemicals
UV9392C - (octyloxyphenyl)phenyliodonium hexafluoro antimonate - GE Silicones
NT—not transparent;
T—transparent

The data of Table 23 demonstrate that improvements in CTE may be obtained by use of a combination of fused colloidal silica and colloidal silica prepared according to embodiments of the invention.

### Example 27

### Preparation of Molding Compound

Fused silica FB-5LDX from Denka Corporation is blended with compatibilized colloidal silica epoxy resin in Speed Mixer DAC40OFV from Hauschild Company. The resulting paste is blended with (4-Octyloxypheny) phenyliodonium hexafluoro antimonate from GE Silicones (Pittsfield, Mass.) and benzopinacole from Aldrich, carbon black and candelilla wax using the same mixer. The resulting molding compound is stored at a temperature below 5 degrees Celsius.

TABLE 24

| | Sample | Sample | Sample | Sample | Sample | Sample | Sample | Sample | Sample |
|---|---|---|---|---|---|---|---|---|---|
| | 115 | 116 | 117 | 118 | 119 | 120 | 121 | 122 | 123 |
| Composition/pph | | | | | | | | | |
| Sample used as resin | 0 | 0 | 0 | Sample | Sample | Sample | Sample | Sample | Sample |
| | | | | 69 | 71 | 69 | 92 | 99 | 100 |
| FB-5LDX | 79.8 | 84.85 | 89.9 | 79.8 | 79.8 | 79.5 | 0 | 0 | 0 |
| UVR6105 | 19.9 | 14.925 | 9.95 | 0 | 0 | 0 | 0 | 0 | 0 |
| Resin amount | 0 | 0 | 0 | 19.9 | 19.9 | 19.7 | 98.5 | 98.5 | 98.5 |
| UV9392C | 0.2 | 0.15 | 0.1 | 0.2 | 0.2 | 0.2 | 0.2 | 0.2 | 0.2 |
| Benzopinacol | 0.1 | 0.075 | 0.05 | 0.1 | 0.1 | 0.1 | 0.1 | 0.1 | 0.1 |
| Carbon Black | 0 | 0 | 0 | 0 | 0 | 0.2 | 0.2 | 0.2 | 0.2 |
| Candelilla Wax | 0 | 0 | 0 | 0 | 0 | 0.2 | 0.2 | 0.2 | 0.2 |
| Properties | | | | | | | | | |
| Spiral Flow | TLV | 18 | DNF | 36 | 33.5 | — | — | — | — |
| CTE (ppm/° C.) | 16.4 | 12.6 | 10.5 | 10.5 | 10 | 12.3 | 12.2 | 12.7 | 12.3 |

FB-5LDX - fused silica - Denka Corporation
UVR6105 - cycloaliphatic epoxy resin - Dow Chemicals
UV9392C - (octyloxyphenyl)phenyliodonium hexafluoro antimonate - GE Silicones
DNF - can not transfer mold - due to lack of flow
TLV - can not transfer mold because viscosity is too low

The results of Table 24 demonstrate the beneficial combination of improved flow and reduced CTE obtained for the samples containing colloidal silica.

### Example 28

### Compression Molding

Flex-bars for CTE measurements are prepared by a compression molding using Tetrahedron pneumatic press. Molding conditions: Molding temperature—350 degrees Celsius; Molding pressure—10000 psi; Molding time—15 min.

### Example 29

### Transfer Molding

Spiral flow experiments are done using a transfer molding press Gluco E5 manufacture by Tannewits-Ramco-Gluco. Clamp forces of 5 tons at an operating pressure of 100 psi. Maximum plunger force—1200 psi.

Cure conditions are: Plunger pressure—660 psi; Plunger time—25 sec; Clamp time—100 sec; Clamp force—5 tons; Mold—standard spiral flow mold.

TABLE 25

| | Sample | Sample | Sample | Sample | Sample |
|---|---|---|---|---|---|
| | 124 | 125 | 126 | 127 | 128 |
| Composition/pph | | | | | |
| Resin Type/Run | Sample | Sample | Sample 92 | Sample 98 | Sample 95 |
| | 92 | 99 | | | |
| FB-5LDX | 74.34 | 74.34 | 84.575 | 84.575 | 79.5 |
| Resin amount | 24.785 | 24.785 | 14.9 | 14.9 | 19.7 |
| UV9392C | 0.25 | 0.25 | 0.15 | 0.15 | 0.2 |
| Benzopinacol | 0.125 | 0.125 | 0.075 | 0.075 | 0.1 |
| Carbon Black | 0.25 | 0.25 | 0.15 | 0.15 | 0.2 |
| Candelilla Wax | 0.25 | 0.25 | 0.15 | 0.15 | 0.2 |
| Properties | | | | | |
| Spiral Flow | TLV | 37 | DNF | 1 | 36 |
| CTE (ppm/° C.) | 16 | 14.1 | 8.7 | 8.2 | 12.7 |

FB-5LDX - fused silica - Denka Corporation
UVR6105 - cycloaliphatic epoxy resin - Dow Chemicals
DNF - can not transfer mold - due to lack of flow
TLV - can not transfer mold - due to too low viscosity

### Example 30

### Evaluation of Coefficient of Thermal Expansion (CTE)

CTE for molded bars is measured using Perkin Elmer Thermo-mechanical Analyzer TMA7 in the temperature range from 10 degrees Celsius to 260 degrees Celsius at a heating rate of 10 degrees Celsius/min.

### Example 31

### Preparation of Compatibilized Colloidal Silica Pre-Dispersions

A pre-dispersion (Sample 129) is prepared using the following procedure. A mixture of aqueous colloidal silica (465 grams (grams) available from Nalco as Nalco 1034A containing about 34 wt % silica), isopropanol (800 grams) and phenyltrimethoxy silane (56.5 grams) is heated and stirred at 60-70 degrees Celsius for 2 hours to give a transparent suspension. The resulting pre-dispersion Sample 129 is cooled to room temperature and stored in a glass bottle.

A pre-dispersion (Sample 130) is prepared using the following procedure. A mixture of aqueous colloidal silica (465 (grams); available from Nalco as NALCO 1034A containing about 34 wt % silica), isopropanol (800 grams) and phenyltrimethoxy silane (4.0 grams) is heated and stirred at 60-70 degrees Celsius for 2 hours to give a transparent suspension. The resulting pre-dispersion Sample 130 is cooled to room temperature and stored in a glass bottle.

### Example 32

### Preparation of Resin Containing Compatibilized and Passivated Silica

A 250-milliliter (ml) flask is charged with 100 grams of the colloidal silica pre-dispersion Sample 129, 50 grams of 1-methoxy-2-propanol (Aldrich) as solvent and 0.5 grams of crosslinked polyvinylpyridine. The mixture is stirred at 70 degrees Celsius. After 1 hour the suspension is blended with 50 grams of 1-methoxy-2-propanol and 2 grams CELITE® 545 (a commercially available diatomaceous earth filtering aid), cooled down to room temperature and filtered. The resulting dispersion of compatibilized colloidal silica is blended with 15.15 grams of 3,4-epoxycyclohexylmethyl-3,4-epoxycyclohexane carboxylate (UVR6105 from Dow Chemical Company) and vacuum stripped at 75 degrees Celsius at 1 mmHg to constant weight to yield 31.3 grams of a viscous liquid resin (Sample 131).

### Example 33

### Preparation of Resin Containing Passivated and Compatibilized Silica

A round bottom flask is charged with 100 grams of the colloidal silica pre-dispersion Sample 130 and 100 grams of 1-methoxy-2-propanol. 100 grams of the total mixture is distilled off at 60 degrees Celsius and 50 Torr. 2 grams of hexamethyldisilazane (HMDZ) is added drop-wise to the concentrated dispersion of compatibilized colloidal silica. The mixture is stirred at 70 degrees Celsius for 1 hour. After 1 hour, CELITE® 545 is added to the flask, the mixture is cooled to room temperature and filtered. The transparent dispersion of compatibilized colloidal silica is blended with 14 grams of UVR6105 (Dow Chemical Company) and vacuum stripped at 75 degrees Celsius at 1 mmHg to constant weight to yield 28 grams of viscous liquid resin (Sample 132).

### Example 34

### Preparation of Resin Containing Compatibilized Colloidal Silica

A round bottom flask is charged with 100 grams of Sample 129, 50 grams of 1-methoxy-2-propanol as solvent, and 0.5 grams of crosslinked polyvinylpyridine. The mixture is stirred at 70 degrees Celsius. After 1 hour the suspension is blended with 50 grams of 1-methoxy-2-propanol and 2 grams CELITE® 545, cooled down to room temperature and filtered. The resulting dispersion of compatibilized colloidal silica is blended with 10 grams of 3,4-epoxycyclo hexylmethyl-3,4-epoxycyclohexane carboxylate (UVR6105 from Dow Chemical Company) and 3.3 grams of bisphenol-F epoxy resins (RSL-1739 from Resolution Performance Product) vacuum stripped at 75 degrees Celsius at 1 mmHg to constant weight to yield 29.4 grams of a viscous liquid resin (Sample 133).

### Example 35

### Preparation of Curable Epoxy Formulations

The compatibilized colloidal silica resins of Samples 131, 132, and 133 are blended separately at room temperature with determined amounts of 4-methyl-hexahydrophthalic anhydride (“MHHPA”) (see Tables below). Subsequently, amounts of catalyst and optional additives as set forth in the Tables below are added at room temperature. The formulations are blended at room temperature for approximately 10 minutes, and the formulation is degassed at room temperature for 20 minutes. Cure of the blended composition is accomplished in two stages: first passing the blended composition through a reflow oven at peak temperature of 230 degrees Celsius; and subjecting the blended composition to a subsequent post cure for 60 minutes at 160 degrees Celsius.

Glass transition temperature (T_{g}) is determined by non-isothermal DSC experiments performed with Differential Scanning Calorimeter (“DSC”) TA Instruments Q100 system. Approximately 10 mg samples of the underfill material are sealed in aluminum hermetic pans. The sample is heated with rate of 30 degrees Celsius/min from room temperature to 300 degrees Celsius. The heat flow during a curing is recorded. T_{g} is determined based on the second heating cycle of the same sample. T_{g} and CTE of cured underfill materials are determined by Thermal Mechanical Analyzer (“TMA”) TMA7 from Perkin Elmer.

The solder fluxing test is performed using clean copper-laminated FR-4 board. A drop (0.2 grams) of each blended formulation is dispensed on the copper laminate and a few solder balls (from about 2 to about 20) are placed inside the drop. Subsequently, the drop is covered with a glass slide and the copper plate is passed through a reflow oven at a peak temperature of 230 degrees Celsius. The solder balls spread and coalescence is examined under an optical microscope. The following scale is used to rate ability to flux:

1 - no change in the shape of solder balls
2 - solder starts to collapse
3 - solder balls are collapsed but do not coalesce
4 - solder balls are collapsed and some coalescent is observed
5 - solder balls are collapsed and complete coalescent is observed

Table 26 below illustrates comparitive no-flow underfill based upon UVR6105 resin, anhydride and hydroxyl group containing compound to flux.

TABLE 26
Comparative examples

| | C1 | C2 | C3 | C4 |
|---|---|---|---|---|
| Components | | | | |
| UVR6105 | 5 | 5 | 5 | 5 |
| Fused Silica - FB-5LDX | — | — | 5 | 5 |
| MHHPA | 4.8 | 4.8 | 4.8 | 4.8 |
| Al(acac)₃/g | 0.1 | 0.02 | 0.1 | 0.02 |
| UVR6000 | 0.66 | — | 0.66 | — |
| Glycerol | — | 0.22 | — | 0.22 |
| Properties | | | | |
| Fluxing | 2 | 5 | 1 | 1 |
| Tg (TMA)/° C. | 175 | ND | 170 | ND |
| CTE (TMA)/ppm/° C. | 69 | ND | 42 | ND |

UVR 6000 is 3-ethyl-3-hydroxy methyl oxetane, an oxetane diluent commercially available from Dow Chemical Company

As can be seen in Table 26, the formulation with a high concentration of A1(acac)₃ (1A) cured too fast, with marginal fluxing. The incorporation of micron-sized fused silica (FB-5LDX from Denka) inhibited fluxing and reduces CTE from about 70 ppm/degree Celsius (unfilled encapsulant) to about 42 ppm/degree Celsius.

Table 27 below illustrates the capability of the novel no-flow underfill based upon Samples 131 and 132 to flux. Effect of type of compatibilized colloidal silica on fluxing properties of underfill material.

TABLE 27

| | Sample | Sample | Sample | Sample |
|---|---|---|---|---|
| Components | 134 | 135 | 136 | 137 |
| Sample 131 | 10 | 10 | — | — |
| Sample 132 | — | — | 10 | 10 |
| MHHPA | 4.8 | 4.8 | 4.8 | 4.8 |
| Catalyst Type | Al(acac)₃ | Al(acac)₃ | Al(acac)₃ | Al(acac)₃ |
| Catalyst Amount/ | 0.02 | 0.02 | 0.02 | 0.02 |
| UVR6000 | 0.66 | — | 0.66 | — |
| Glycerol | — | 0.22 | — | 0.22 |
| Properties | | | | |
| Fluxing | 4 | 3 | 5 | 4 |
| T_{g} (TMA)/° C. | 156 | — | 152 | 188 |
| CTE (TMA)/ppm/° C. | 50 | — | 42 | 40 |

Formulations containing compatibilized colloidal silica showed flux of solder. Combination of passivated compatibilized colloidal silica (Sample 132) and A1(acac)₃ had better stability at room temperature, better fluxing and lower CTE.

Table 28 below illustrates the capability of the novel no-flow underfill based upon Sample 131 to flux and also demonstrates the effect of catalyst on fluxing properties of the underfill material.

TABLE 28

| | Sample | Sample | Sample | Sample | Sample | Sample | Sample |
|---|---|---|---|---|---|---|---|
| Components | 138 | 139 | 140 | 141 | 142 | 143 | 144 |
| Sample 131/g | 5 | 5 | 5 | 5 | 5 | 5 | 5 |
| MHHPA/g | 2.33 | 2.33 | 2.33 | 2.33 | 2.33 | 2.33 | 2.33 |
| Catalyst Type | Al(acac)₃ | Tin Octoate | DBTDL | DY- | P(Ph)₃ | Polycat | none |
| | | | | 070US | | SA-1 | |
| Catalyst Amount/g | 0.025 | 0.025 | 0.025 | 0.025 | 0.025 | 0.022 | none |
| Fluxing | 3 | 1 | 5 | 1 | 4 | 5 | 5 |
| T_{g} (DSC) | 90 | ND | 141 | 197 | 198 | 181 | 120 |

Al(acac)₃ - Aldrich
Tin Octoate - Aldrich
DBTDL - DibutylTin Dilaurate (GE Silicones)
DY 070 US - N-methyl Imidazole (Ciba)
PPh₃ - Aldrich
POLYCAT ® SA-1 - phenolic complex of DBU (Air Products)

As seen from Table 28, the bestetter fluxing and higher glass transition temperature is reached in the presence of POLYCAT® SA-1 and PPh₃ as catalyst. The uncatalyzed formulation of particles, and formulation catalyzed with DBTDL, were able to flux solder balls during reflow but the observed T_{g} is lower.

The formulation based on Sample 131 with MHHPA showed fluxing without any catalysts, but the resin had lower T_{g} after reflow. Formulation UVR6105/MHHPA did not flux well under these conditions.

Table 29 below illustrates the capability of the novel no-flow underfill based upon Sample 131 to flux and the effect of the concentration of catalyst (POLYCAT® SA-1, from Air Products) on the fluxing properties of the no-flow underfill material. In each sample, the catalyst is POLYCAT SA-1.

TABLE 29

| | Sample | Sample | Sample | Sample | Sample | Sample |
|---|---|---|---|---|---|---|
| | 145 | 146 | 147 | 148 | 149 | 150 |
| Components | | | | | | |
| Sample 131/g | 5 | 5 | 5 | 5 | 5 | 5 |
| MHHPA/g | 2.33 | 2.33 | 2.33 | 2.33 | 2.33 | 2.33 |
| Wt % Catalyst | 2 | 1.000 | 0.5 | 0.3 | 0.2 | 0.1 |
| Properties | | | | | | |
| Fluxing | 1 | 1 | 1 | 3 | 5 | 5 |
| Tg (DSC)/° C. | 185 | 174.67 | 192.82 | 185.43 | 176.03 | 181.15 |
| CTE | 45 | 48 | — | 46 | 46.5 | — |
| (TMA) ppm/ | | | | | | |
| ° C. | | | | | | |

As can be seen from Table 29, a high concentration of POLYCAT SA-1 promoted too fast a cure and no fluxing is observed. Formulations with a POLYCAT SA-1 concentration below 0.3 weight percent showed fluxing of solder balls. Samples 145-150 have a low CTE, below 50 ppm.

### Example 36

Samples 131 and 132 form a no-flow underfill composition by adding MHHPA and PPh3 as a catalyst. Both fluxing and T_{g} are determinable. T_{g} is determined by DSC. The amounts of the components in the compositions, and the observed fluxing and T_{g} are set forth below in Table 30.

TABLE 30

| | Sample | Sample | Sample | Sample |
|---|---|---|---|---|
| Components | 151 | 152 | 153 | 154 |
| Sample 132/g | 5 | 5 | — | — |
| Sample 131/g | — | — | 5 | 5 |
| MHHPA/g | 2.33 | 2.33 | 2.33 | 2.33 |
| wt % PPh₃ | 0.5 | 0.25 | 0.5 | 0.25 |
| Properties | | | | |
| Fluxing | 2 | 4 | 3 | 4 |
| T_{g} (DSC)/° C. | 179 | 175 | 178.7 | 157.8 |

### Example 37

Sample 133 forms a no-flow underfill composition by adding MHHPA and catalyst. Fluxing, CTE and T_{g} are determined. T_{g} and CTE are determined by TMA. The amounts of the components in the compositions and the observed fluxing, CTE and T_{g} are set forth below in Table 31.

TABLE 31

| Components | Sample 155 | Sample 156 | Sample 157 |
|---|---|---|---|
| Sample 133/g | 5 | 5 | 5 |
| MHHPA/g | 2.08 | 2.08 | 2.08 |
| Catalyst Type | DBTDL | Al(acac)₃ | Polycat-SA1 |
| Wt % Catalyst | 0.2 | 0.2 | 0.2 |
| Properties | | | |
| Fluxing | 4.5 | 1 | 4 |
| T_{g} (DSC)/° C. | 142 | — | 156 |
| CTE (TMA) ppm/° C. | 46 | — | 44 |

As is apparent from the above data, some formulations show relatively better fluxing. Catalyst selection may positively affect fluxing, T_{g} and CTE, and catalyst concentration may be optimized to maximize fluxing. For example, formulations with a lower concentration of PPh₃ (below 0.3 weight percent) showed acceptable fluxing.

The foregoing examples are illustrative of some features of the invention. The appended claims are intended to claim the invention as broadly as has been conceived and the examples herein presented are illustrative of selected embodiments from a manifold of all possible embodiments. Accordingly, it is Applicants' intention that the appended claims not limit to the illustrated features of the invention by the choice of examples utilized. As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges there between. It is to be expected that variations in these ranges will suggest themselves to a practitioner having ordinary skill in the art and, where not already dedicated to the public, the appended claims should cover those variations. Advances in science and technology may make equivalents and substitutions possible that are not now contemplated by reason of the imprecision of language; these variations should be covered by the appended claims.

1. A curable composition, comprising:
a curable resin; and
a finely divided refractory solid having a surface area that is greater than about 5 square meters per gram; and, a determined density of active surface termination sites per square nanometer of surface area.

2. The curable composition as defined in claim 1, wherein the determined density is sufficiently low that the curable composition comprising less than about 99 percent by weight of the solid has a stability ratio of less than about 3 after a period of about two weeks.

3. The curable composition as defined in claim 1, wherein the surface area is greater than about 20 square meters per gram.

4. The curable composition as defined in claim 1, wherein the stability ratio is about 1.

5. The curable composition as defined in claim 1, wherein the density of active surface termination sites is about 4.75 or less.

6. The curable composition as defined in claim 1, wherein the density of active surface termination sites is in a range of from about 4.5 to about 4.0.

7. The curable composition as defined in claim 1, wherein the solid comprises a plurality of nano-particles having an average diameter in a range of from about 1 nanometer to about 100 nanometers.

8. The curable composition as defined in claim 1, wherein the solid comprises one or more of aluminum, antimony, arsenic, beryllium, boron, carbon, chromium, copper, gallium, gold, germanium, indium, iron, hafnium, magnesium, manganese, molybdenum, phosphorous, silicon, silver, titanium, tungsten, or zirconium.

9. The curable composition as defined in claim 8, wherein the solid comprises an oxide or a nitride of one or more of aluminum, antimony, arsenic, beryllium, boron, carbon, chromium, copper, gallium, gold, germanium, indium, iron, hafnium, magnesium, manganese, molybdenum, phosphorous, silicon, silver, titanium, tungsten, or zirconium.

10. The curable composition as defined in claim 9, wherein the solid comprises silicon oxide and the active surface termination site comprises a silanol group.

11. The curable composition as defined in claim 9, wherein the solid comprises alumina oxide and the active surface termination site comprises a hydroxyl group.

12. The curable composition as defined in claim 9, wherein the solid is a nitride and the active surface termination site comprises an amide or an imide.

13. The curable composition as defined in claim 1, wherein the solid is a reaction product of:
a plurality of particles, wherein each particle has a plurality of reactive surface groups;
a compatibilizing composition; and
a passivating composition.

14. The curable composition as defined in claim 13, wherein the compatibilizing composition comprises a silane.

15. The curable composition as defined in claim 14, wherein the compatibilizing composition comprises phenyl trimethoxysilane.

16. The curable composition as defined in claim 13, wherein the passivating composition comprises a silylating composition.

17. The curable composition as defined in claim 13, wherein the passivating composition comprises a silazane.

18. The curable composition as defined in claim 1, wherein the curable resin comprises one or more of an acrylic resin, methacrylate resin, isocyanate resin, cyanate ester resin, imide resin, benzocyclobutene resin, polyester resin, polyphenylene ether resin, polyphenylene oxide resin, siloxane resin, polyallyl ether resin, polyimidoamide resin, polyamide resin, or oxirane resin; or, a halogenated derivative of one or more of the foregoing.

19. The curable composition as defined in claim 18, wherein the curable resin comprises one or more of epoxy, oxetane, polyimide resin, methyl methacrylate resin, polydimethyl siloxane resin, bismaleimide resin, or bismaleimide triazine resin.

20. The curable composition as defined in claim 1, wherein the curable resin comprises a cycloaliphatic epoxy monomer selected from the group consisting of 3-cyclohexenyl methyl-3-cyclohexenyl carboxylate diepoxide; 3-(1,2-epoxyethyl)-7-oxabicycloheptane; hexanedioic acid; bis(7-oxabicyclo heptylmethyl)ester; 2-(7-oxabicyclohept-3-yl)spiro(1,3-dioxa-5,3′-(7)-oxabicycloheptane; and methyl 3,4-epoxycyclohexane carboxylate.

21. The curable composition as defined in claim 20, wherein the curable resin comprises an aliphatic epoxy monomer selected from the group consisting of butadiene dioxide; dimethylpentane dioxide; diglycidyl ether; 1,4-butane diol diglycidyl ether; diethylene glycol diglycidyl ether; and dipentene dioxide.

22. The curable composition as defined in claim 1, further comprising a removable or extractable solvent.

23. The curable composition as defined in claim 22, wherein the solvent comprises one or more of 1-methoxy-2-propanol, butyl acetate, methoxyethyl ether, methoxy propanol acetate, or a small chain alcohol.

24. The curable composition as defined in claim 1, further comprising a catalyst selected from the group consisting of triphenyl phosphine, N-methylimidazole, and butyl tin dilaurate.

25. The curable composition as defined in claim 1, further comprising one or more of a flame retardant, adhesion promoter, reactive organic diluent, or a curing agent.

26. The curable composition as defined in claim 1, wherein the solid is present in an amount sufficient to about match the coefficient of thermal expansion of the curable composition to a chip selected for use with the curable composition.

27. The curable composition as defined in claim 1, wherein the solid is present in an amount in a range of greater than about 1 weight percent based on the total weight of the curable composition.

28. The curable composition as defined in claim 1, further comprising at least one resin hardener selected from the group consisting of phenol novolac resin hardeners, hydroquinone, resorcinol, and combinations of two or more thereof.

29. An underfill composition comprising:
the curable composition as defined in claim 1,
a second curable composition comprising at least one epoxy resin, and the second curable composition being capable of fluxing; and
a hardener capable of reacting with the at least one epoxy resin, wherein the hardener comprises an anhydride.

30. The underfill composition as defined in claim 29, wherein the hardener comprises a siloxane anhydride having a structure of formula (IV), (V), or (VI): 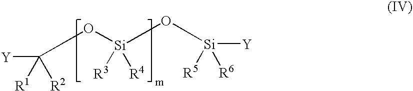
where “m” is an integer in a range of from 0 to about 50 inclusive, and each of R1, R2, R3, R4, R5 and R6 are independently a C₁₋₂₂alkyl, C₁₋₂₂alkoxy, C₂₋₂₂alkenyl, C₆₋₁₄aryl, C₆₋₂₂alkyl-substituted aryl, or C₆₋₂₂arylalkyl; 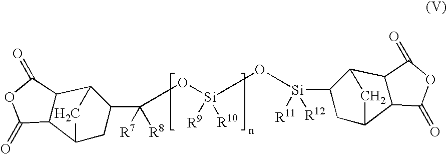
where “n” is an integer in a range of from 0 to about 50 inclusive, and each of R7, R8, R9, R10, R11 and R12 are independently a C₁₋₂₂alkyl, C₁₋₂₂alkoxy, C₂₋₂₂alkenyl, C₆₋₁₄aryl, C₆₋₂₂alkyl-substituted aryl, or C₆₋₂₂arylalkyl; or 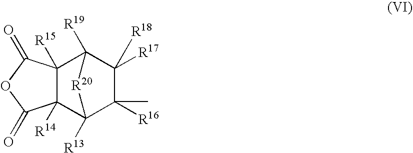
where R13-R19 is hydrogen, halogen, a C1 or greater monovalent hydrocarbon radical, or a substituted C1 or greater hydrocarbon radical, and R20 is oxygen or —C—R21, wherein R21 is any two selected from the group consisting of hydrogen, halogen, a C1 or greater monovalent hydrocarbon radical, and a substituted C1 or greater hydrocarbon radical.

31. The underfill composition as defined in claim 29, wherein the hardener comprises one or more of methyl hexahydrophthalic anhydride; methyl tetrahydrophthalic anhydride; 1,2-cyclohexane dicarboxylic anhydride; bicyclo (2.2.1)hept-5-ene-2,3-dicarboxylic anhydride; methylbicyclo(2.2.1)hept-5-ene-2,3-dicarboxylic anhydride; phthalic anhydride; pyromellitic dianhydride; hexahydrophthalic anhydride; dodecenylsuccinic anhydride; dichloromaleic anhydride; chlorendic anhydride; or tetrachlorophthalic anhydride.

32. A transparent B-staged film made by the underfill composition as defined in claim 29.

33. A cured layer formed from the composition as defined in claim 1.

34. The cured layer as defined in claim 33, and having a transparency of greater than 50 percent light transmission.

35. The cured layer as defined in claim 33, and having a glass transition temperature that is greater than about 140 degrees Celsius.

36. The cured layer as defined in claim 33, and having coefficient of thermal expansion of less than about 50 ppm/° C.

37. An electronic device, comprising:
a chip;
a substrate; and
the cured layer as defined in 33 securing the chip to the substrate.

38. The electronic device as defined in 37, wherein the cured layer is an underfill material disposed in a region defined by an inward facing surface of the chip and an inward facing surface of the substrate.

39. A method of producing a filled curable composition, comprising:
reacting a first portion of active termination sites of a plurality of particles with a compatiblizing composition to form compatibilized particles;
reacting a second portion of active termination sites of the plurality of particles with a passivating composition to form compatibilized and passivated particles; and
mixing the plurality of compatiblized and passivated particles with a curable resin to form the filled curable composition.

40. The method as defined in claim 39, wherein the reacting the first and second portions are performed in the presence of a solvent, and the method further comprises removing the solvent from a solution or slurry comprising the plurality of compatiblized and passivated particles prior to mixing with the curable resin.

41. The method as defined in claim 39, wherein reacting the second portion of active termination sites comprises capping or passivating active termination sites on a surface of each particle of the plurality to achieve less than about 4.75 active termination sites per square nanometer of surface area.

42. The method as defined in claim 39, wherein the step of mixing further comprises mixing a siloxane anhydride with the plurality of compatiblized and passivated particles with the curable resin.

43. The method as defined in claim 39, wherein the filled curable composition comprises a solvent, and the method further comprises removing the solvent from the filled curable composition to form a tack-free B-staged film.

44. The method as defined in claim 43, further comprising curing the B-staged film to form a transparent, low CTE, high Tg film.

45. The method as defined in claim 43, further comprising heating the B-staged resin film to a temperature in a range of from about 50 degrees Celsius to about 250 degrees Celsius at a pressure in a range of from about 75 mmHg to about 250 mmHg.

46. An article, comprising:
a wafer having one or more dicing guide marks on a surface of the chip, and disposed on the surface of the wafer is:
means for securing a chip that is diced from the wafer to a substrate.

47. The article as defined in claim 46, wherein the means for securing the chip is capable of transmitting sufficient light so that guide marks on the surface are not obscured by the securing means during a dicing process of the wafer to form the chip.

48. A no-flow underfill composition, comprising:
a curable resin; and
a finely divided refractory solid having a surface area that is greater than about 5 square meters per gram; and, a determined density of active surface termination sites per square nanometer of surface area, wherein
the underfill composition has a viscosity at a dispensing temperature that is sufficiently low to be syringe dispensable onto a surface of a chip, and that is sufficiently high to preclude or minimize flow of the underfill composition during placement of the chip during a flip-chip placement operation, and
the underfill composition is capable of achieving a sufficiently high degree of conversion during cure, in which the cure is of a sufficiently high temperature that a solder joint embedded in a matrix defined by the underfill flows and forms an electrical connection.

49. The no-flow underfill composition as defined in claim 48, wherein an initial viscosity of the no-flow underfill composition immediately after mixing the curable resin and the finely divided refractory solid is less than 10 percent different than a subsequent viscosity of the no-flow underfill composition measured after about six weeks.

50. The no-flow underfill composition as defined in claim 48, further comprising a siloxane anhydride, and wherein the curable resin is selected from the group consisting of epoxy resins, acrylate resins, polyimide resins, polyurethane resins, benzocyclobutene resins, bismaleimide triazine resins, fluorinated polyallyl ether resins, polyamide resins, polyimidoamide resins, phenol resol resins aromatic polyester resins, polyphenylene ether resins, polyphenylene oxide resins, siloxane resins, and combinations of two or more thereof.

51. A cured film formed from the no-flow underfill composition as defined in claim 48, wherein the film has a coefficient of thermal expansion of less than about 50 ppm/degree Celsius; the film has a transparency sufficient that guide marks on a pre-diced wafer are observable through the width of the film; the solder joint is free of lead and is sufficiently fluxed during cure of the film that the electrical connection few or no defects; or a combination of two or more of the foregoing.
